(19) United States
(12) Patent Application Publication
(10) Pub. No.: US 2021/0027248 A1
(43) Pub. Date: Jan. 28, 2021

(54) NON-LINEAR AND COLLABORATIVE SYSTEMS AND METHODS FOR SOCIAL GOOD INNOVATION

(71) Applicant: University of San Diego, San Diego, CA (US)

(72) Inventors: Lisa Dawley, San Diego, CA (US); Monte Kalisch, Broomfield, CO (US)

(21) Appl. No.: 16/938,597

(22) Filed: Jul. 24, 2020

Related U.S. Application Data
(60) Provisional application No. 62/878,974, filed on Jul. 26, 2019.

(51) Int. Cl. G06Q 10/10; G09B 5/12; G09B 19/00

(52) U.S. Cl. CPC G06Q 10/103; G06Q 10/101; G09B 19/00; G09B 5/12

(57) ABSTRACT

Methods, systems, and devices for non-linear and collaborative on-line management of a project are disclosed. An example method includes displaying, to a user, an account login dialog box, receiving, from the user, user credentials that correspond to a student account or a teacher account on an educational software platform, displaying, upon verification of the user credentials, a first plurality of icons corresponding to a plurality of projects, each project of the plurality of projects being categorized by a social issue corresponding to an organizational goal, receiving an innovation project selection from the plurality of projects, displaying, for a selected innovation project, a second plurality of icons corresponding to four phases, receiving a phase selection from the four phases, and displaying, for a selected phase, a third plurality of icons corresponding to three steps.

### CROSS-REFERENCE TO RELATED APPLICATION

This patent document claims priority to and benefit of U.S. Provisional Patent Application No. 62/878,974 entitled “SYSTEM AND METHOD FOR NON-LINEAR, COLLABORATIVE SOCIAL GOOD INNOVATION” and filed on Jul. 26, 2019. The entire content of the before-mentioned patent application is incorporated by reference as part of the disclosure of this patent document.

### TECHNICAL FIELD

This patent document is directed generally to collaborative methods for learning, and more particularly, non-linear and collaborative systems and methods for social good innovation.

### BACKGROUND

For an increasing number of countries, spurred by technological advances and increased access to global markets, innovation is a leading driver of economic growth and prosperity. New technologies and the emergence of social, economic, and policy reforms are creating new entry points to address the development challenges that span technology innovations, alternative finance models or experimentation policy. As a result, governments are starting to invest in social innovation approaches to better engage with citizens, establish their overall legitimacy and create the next generation of services.

### SUMMARY

The disclosed technology relates to devices, systems, and methods that enable non-linear, personalized, collaborative social good innovation and learning. In an example, social good innovation is the process of developing and deploying effective solutions to challenging and often systemic social and environmental issues in support of social progress. The technology categorizes by key social issues, for example the United Nations Sustainable Development Goals (“SDGs”). The technology includes personalized, non-linear learning and innovation systems and methods that utilize specialized software and associated hardware devices that operate in a distributed networked environment.

In one aspect, the disclosed technology may be used to provide a method for non-linear and collaborative on-line management of a project that includes displaying, via a graphical user interface (GUI) to a user, an account login or account creation dialog box, receiving, from the user, user credentials that correspond to a student account or a teacher account on an educational software platform, displaying, upon verification of the user credentials, a first plurality of icons corresponding to a plurality of projects, each project of the plurality of projects being categorized by a social issue corresponding to an organizational goal, receiving an innovation project selection from the plurality of projects, displaying, for a selected innovation project, a second plurality of icons corresponding to four phases: (a) an understanding phase related to understanding a complexity of a problem corresponding to the social issue and how it affects people, (b) an ideation phase related to developing ideas and potential solutions to the problem using one or more collaboration tools built into the educational software platform, (c) a prototyping phase related to producing a prototype associated with the selected innovation project based on the ideas and potential solutions, and (d) a pitch phase related to developing a presentation associated with the selected innovation project that highlights the prototype, receiving a phase selection from the four phases, and displaying, for a selected phase, a third plurality of icons corresponding to three steps: (i) an exploration step configured to provide the user with information and resources related to the selected innovation project and the social issue, (ii) an activity step configured to enable the user to perform one or more of a plurality of activities related to the selected innovation project, and (iii) a documentation step configured to enable the user to link one or more documents to the selected innovation project, wherein performing the one or more phases includes performing the four phases and three steps in a non-linear manner that includes accessing the four phases and three steps any particular number of times and in any particular order to enable the user to achieve one or more learning objectives without relying on a predetermined or customized curriculum that can be accessed through the educational software platform.

In another aspect, the disclosed technology may be used to provide another method for non-linear and collaborative on-line management of a project that includes accessing, via a graphical user interface, a first user account for interaction with an educational software platform that is configured to support a student account and a teacher account, selecting an innovation project from a plurality of projects, each project of the plurality of projects being categorized by a social issue corresponding to an organizational goal, and utilizing one or more resources built into the educational software platform to perform one or more of four phases: (a) an understanding phase related to understanding a complexity of a problem corresponding to the social issue and how it affects people, (b) an ideation phase related to developing ideas and potential solutions to the problem using one or more collaboration tools built into the educational software platform, (c) a prototyping phase related to producing a prototype associated with the innovation project based on the ideas and potential solutions, and (d) a pitch phase related to developing a presentation associated with the innovation project that highlights the prototype, wherein performing the one or more of the four phases includes performing the phases (a), (b), and (c) in a non-linear manner that includes accessing the phases (a), (b), and (c) any particular number of times and in any particular order to enable a user of the first user account to achieve one or more learning objectives without relying on a predetermined or customized curriculum that can be accessed through the educational software platform, and wherein the one or more resources comprise the one or more collaboration tools enabling information sharing between a plurality of student accounts and a review tool enabling two-way interaction between the teacher account and the student account.

In another aspect, an apparatus comprising a memory and a processor implements the above-described methods is disclosed.

In yet another aspect, the method may be embodied as processor-executable code and may be stored on a non-transitory computer-readable program medium.

The above and other aspects and features of the disclosed technology are described in greater detail in the drawings, the description and the claims.

### BRIEF DESCRIPTION OF THE DRAWINGS

FIG. 1 illustrates a flow chart diagram showing the operation of the social good innovation process from the perspective of a student user.

FIG. 2 illustrates a flow chart diagram showing the operation of the social good innovation process from the perspective of a teacher user.

FIG. 3 illustrates a flow chart diagram showing the process of logging a student user in or creating a student user account.

FIG. 4 illustrates a flow chart diagram showing the process of logging a teacher user in or creating a teacher user account.

FIG. 5 illustrates a page prompting a user to either login or create an account

FIG. 6 illustrates a page for creating a user and associating a user with a class.

FIG. 7 illustrates a first-time student user's dashboard page.

FIG. 8 illustrates a flow chart diagram showing how a student user can interact with an example Innovator's Guide.

FIG. 9 illustrates an example “Getting Started” page for an example Innovator's Guide.

FIG. 10 illustrates one page of an example Innovator's Guide that includes information regarding Global Goals—in this example the United Nations Sustainable Development Goals (UN SDGs).

FIG. 11 illustrates an example page of an example Innovator's Guide that provides links to external resources addressing topics relevant to the social good innovation process.

FIG. 12 illustrates a flow chart diagram showing the process of creating a new project or viewing an existing project.

FIG. 13 illustrates a project creation page prompting a user to choose a key social issue to associate a project with.

FIG. 14 illustrates a project creation page prompting a user to input information describing the project.

FIG. 15 illustrates a student user's home page once a student user has is associated with one or more projects.

FIG. 16 illustrates a project's home page.

FIG. 17 illustrates a flow chart diagram showing the student user work flow.

FIG. 18 illustrates an example “Explore” step page of an example “Understand” phase page.

FIG. 19 illustrates an example “Do” step page of an example “Understand” phase page.

FIG. 20 illustrates an example of detailed instructions for an activity under an example “Do” step page of an example “Understand” phase page.

FIG. 21 illustrates an example “Document” step page of an example “Understand” phase page.

FIG. 22 illustrates an example prompt from the software to give the software access to a document sharing site, such as Google Docs.

FIG. 23 illustrates an example prompt to select a document to link to a project phase.

FIG. 24 illustrates an example “Document” step page once a document has been linked.

FIG. 25 illustrates an example indicator showing a student team has submitted documents for one phase of a project.

FIG. 26 illustrates an example project dashboard once a student team has submitted documents for a design thinking phase.

FIG. 27 illustrates an example teacher user dashboard page.

FIG. 28 illustrates a flow chart diagram showing how a teacher user can use the ready for review system.

FIG. 29 illustrates a flow chart diagram showing the teacher user workflow for reviewing and returning or approving documents.

FIG. 30 illustrates an example teacher user page for reviewing documents submitted by student users.

FIG. 31 illustrates an example prompt from the software to a teacher user for the teacher user to provide feedback on student documents.

FIG. 32 illustrates an example indicator showing one phase of a project has had documents returned with feedback.

FIG. 33 illustrates an example project dashboard once documents have been returned with feedback for a phase.

FIG. 34 illustrates an example “Document” step page tracking student team submissions and teacher feedback.

FIG. 35 illustrates an example prompt from the software to a teacher user for the teacher user to include information with an approval of student team documents.

FIG. 36 illustrates an example indicator showing one phase of a project has had documents approved.

FIG. 37 illustrates an example project dashboard once documents have been returned with feedback for a phase.

FIG. 38 illustrates an example “Document” step page with tracking showing a teacher user has approved the student user's documents.

FIG. 39 illustrates an example of the “Showcase” page.

FIG. 40 illustrates an example of filtering by a global goal on the “Showcase” page.

FIG. 41A is an example of a method flowchart for non-linear and collaborative on-line management of a project.

FIG. 41B is another example of a method flowchart for non-linear and collaborative on-line management of a project.

FIG. 42 illustrates a diagram of an example embodiment of a network architecture for implementing the described embodiment.

FIG. 43 illustrates a diagram of an example embodiments of a hardware platform for implementing the described embodiment.

### DETAILED DESCRIPTION

Social good innovation is a process of developing solutions to systemic problems in support of social progress. An example of a set of such systemic problems are the United Nations (“UN”) seventeen Sustainable Development Goals (“SDGs” or “Global Goals”) that outline global problems the UN wants solved by 2030. The process of designing for innovation like social good innovation often does not occur in a set pattern or path and instead requires iteration and returning to rethink prior steps of the design. In contrast, traditional teaching and learning occurs in sequence and lock-step: a teacher works all students through the same sequential steps at the same time, with no returning to rework through prior steps. This difference between the process of designing for innovation and the process of traditional teaching and learning makes traditional teaching and traditional learning environments ineffective means for designing for social good innovation.

Due to the iterative nature of designing for innovation, more effective methods for designing for social good innovation involve innovating in a non-linear form personalized to each individual or team. Non-linear innovation is a form of innovation in which innovators can start at any stage in the design process and proceed or return to any other stage in the process in whatever order they want. Design thinking is a process of identifying strategies and solutions to problems with a focus on iteration and developing a deep understanding of a problem and how it affects people. It is beneficial to provide a technological solution for streamlining the design thinking process and innovation design methodologies to enable access to media, instructions, and feedback in a collaborative networked environment that facilitates innovation.

The disclosed technology of this patent document relates to systems and methods that enable design thinking for social good innovation via non-linear, personalized innovation with a focus on social good innovation linked to key social issues. These goals are achieved using systems and methods that utilize specialized software and associated hardware devices that operate in a distributed networked environment that allows access to pre-existing information and content, as well as real-time or near real-time access to content that is generated by various users and is subjected to a review process. The disclosed embodiments further enable the generation of various signals that provide status information, enable student teams to create and document their own social good innovation projects, and enable teachers to provide feedback and guidance to help student teams on the student teams' process of creating social good innovation solutions. These and other features and benefits are achieved using a systematic set of protocols and methodologies, while still enabling non-linear design innovation.

The disclosed embodiments can be implemented as instructions that are stored on a non-transitory storage medium. The instructions (also referred to as ‘software’ in this document) can be executed by one or more processors, such as one or more microprocessors, to cause the processor(s) to display graphical user interfaces (GUI), receive and process data obtained from the GUI, and to receive/transmit data to various remote locations, such as from/to a database, a server or another electronic device. The collection of networked devices, databases and associated hardware and software is sometimes referred to as the “system” in this document. In the sections that follow, the disclosed embodiments and processes are described using specific, non-limiting example implementations to facilitate the understanding of the disclosed technology.

The disclosed embodiments enable three types of end users: students, teachers, and administrators. One software implementation enables users to learn social good innovation and use design thinking to create projects geared toward using social good innovation to achieve the UN SDGs. The disclosed embodiments enable teachers to monitor student teams' progress on projects and give feedback to student teams on the student teams' work on their projects. The disclosed technology further enables administrators to manage the content available at networked devices as well as to manage which users are students and which are teachers. Additionally, the disclosed technology can enable administrators to provide data to other users such as researchers, data scientists, and analysts to support robust research methods and purposes.

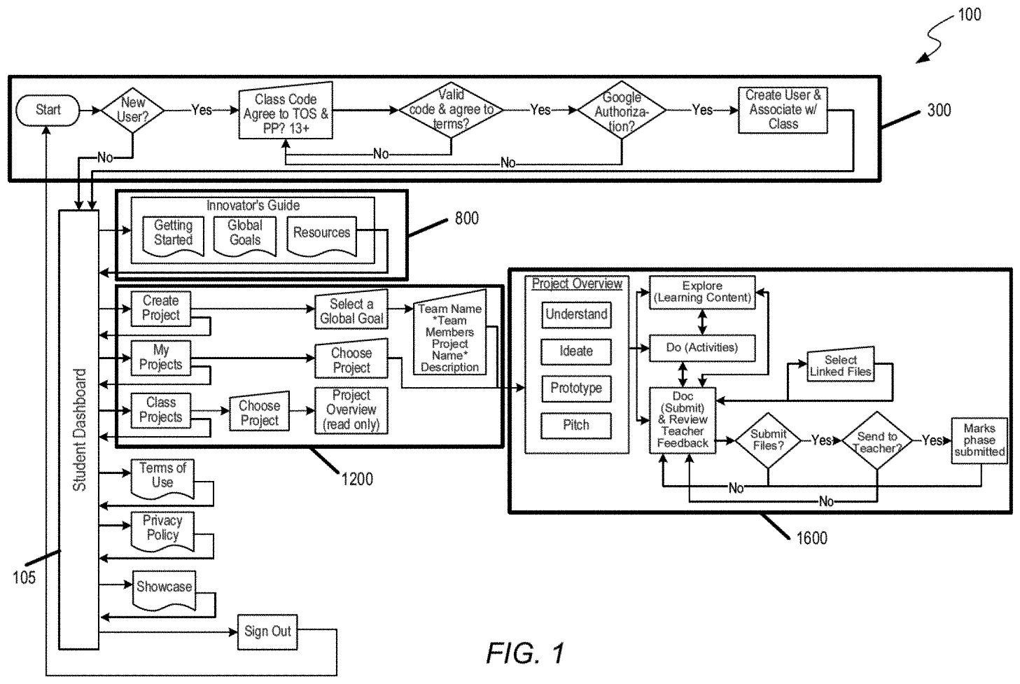

FIG. 1 illustrates a flow chart diagram describing operations for enabling a student user to interact with the system. As illustrated therein, operations begin with the activation (e.g., creating a new account, logging into an existing account) of a student account 300. If an account exists, or once a new account is created, the student user is taken to the student dashboard 105. Various workflows can be controlled through the student dashboard. In an example, the student can interact with the Innovator's Guide 800. In another example, the student can access a project 1200 (e.g., create a new project, open an existing project), and then access the project's homepage 1600. In yet another example, the student can access the showcase, which enables filtering of projects and solutions by goal.

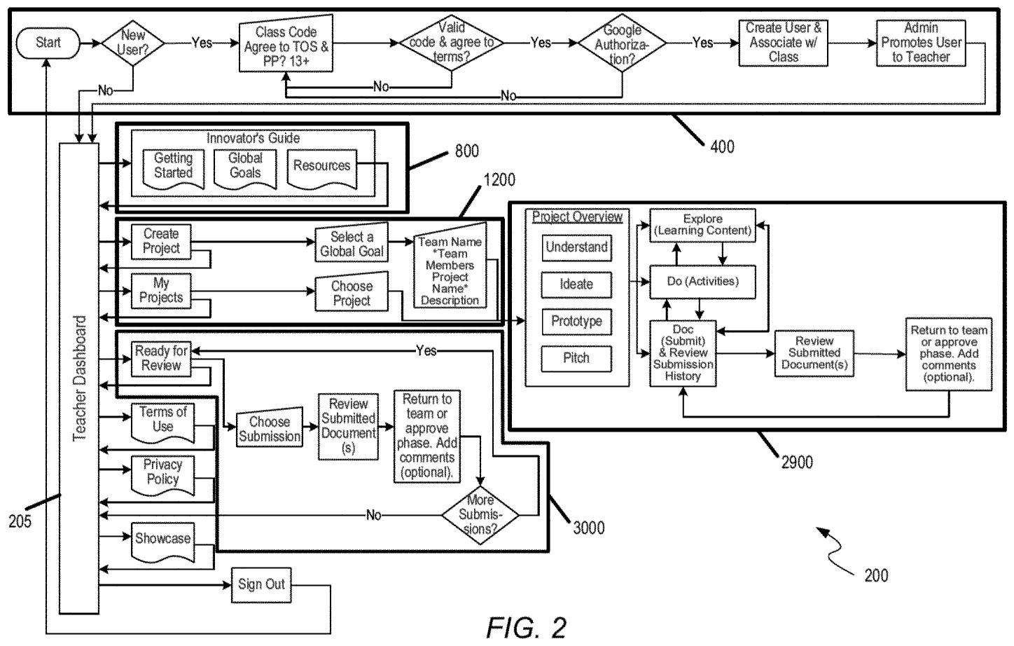

FIG. 2 illustrates a flow chart diagram describing how a teacher user can interact with the system. Similar to the student user interaction, the teacher user interaction begins with the activation (e.g., creating a new account, logging into an existing account) of a teacher account 400. If an account exists, or once a new account is created, the teacher user is taken to the teacher dashboard 205. Various workflows can be controlled through the teacher dashboard. In an example, the teacher can interact with the Innovator's Guide 800. In another example, the teacher can access (e.g., create a new project, open an existing project) a project 1200, and then access the project's homepage 1600. In yet another example, the teacher can use the ready-to-review system 3000, and/or review and return or approve documents 2900. In yet another example, the teacher can access the showcase, which enables filtering of projects and solutions by goal.

As illustrated in FIGS. 1 and 2, embodiments of the educational software platform described in this document enable a student and a teacher, respectively, to access various projects related to organizational goals (e.g., one or more of the seventeen UN SDGs). According to some embodiments, users of the educational software platform can access a variety of resources built into the platform, which can be used to interact and develop ideas and solutions to problems and projects that are characterized by the organizational goals.

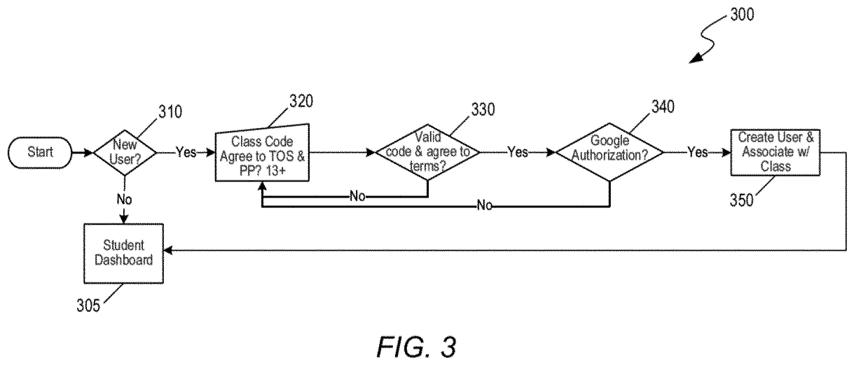

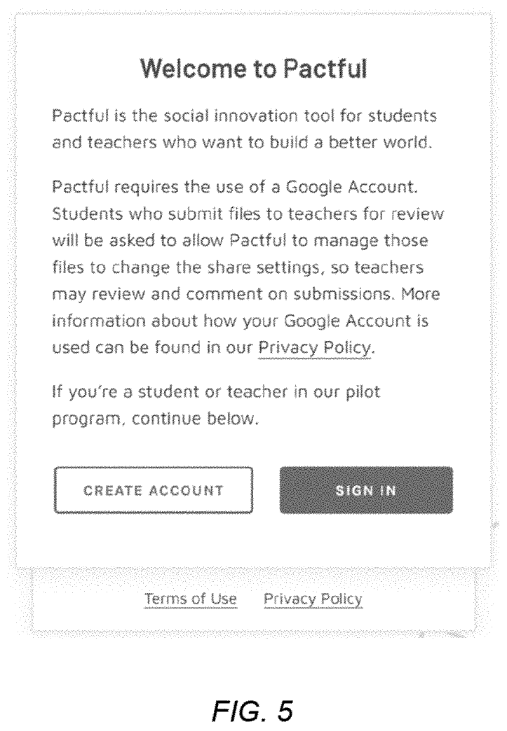

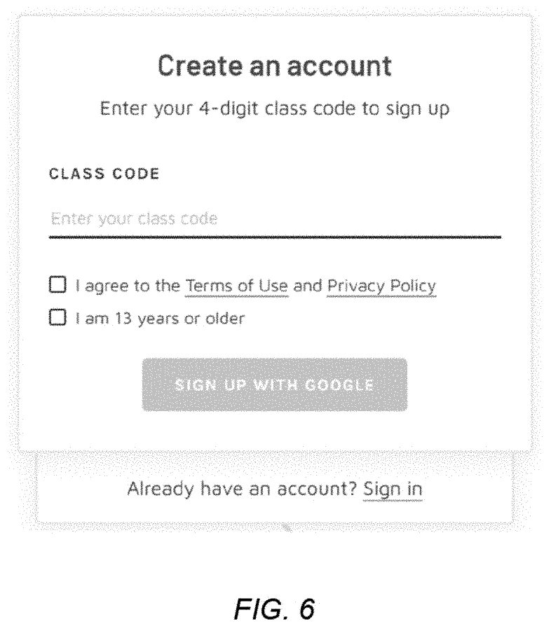

FIG. 3 illustrates a flow chart 300 describing the process of logging a student user in or creating a student user account. As illustrated therein, the process begins with determining whether the student user is a new user (operation 310). If the student user is a new user, the student needs to create an account, whereas a student who is an existing user simply needs to sign in. FIG. 5 shows an example of a user login and user account creation page. If the student user is not a new user, the user can simply login to their existing account using the “Sign In” button shown in FIG. 5. If the user needs to create an account, the process will guide them through that process. To create an account, a student user will first need to enter a class code, an example of which is shown in FIG. 6. The class code will inform the system which class group to associate the user with (operation 320).

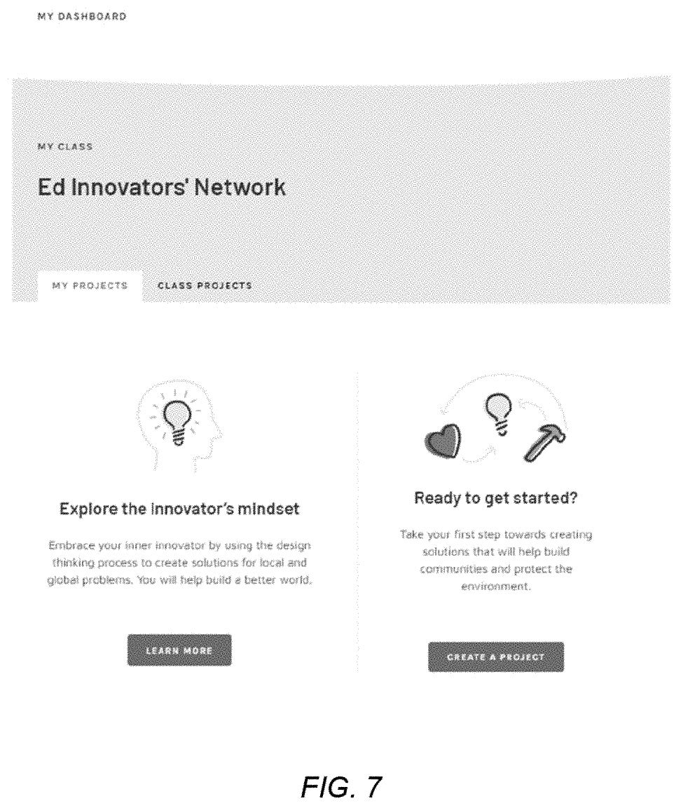

Once the user enters a class code, the process validates the code and may require the user to agree to the terms of use or other policies for using the system (operation 330), an example of which is illustrated in FIG. 6. As shown in FIG. 6, the process may also prompt the user to create an account by signing in with a pre-existing account from another platform, such as a Google account (operation 340). The student account is then created associated with the appropriate class (operation 350) based on the class code that was previously entered. Finally, the student (having either created an account or logged into an existing one) is taken to the student dashboard (operation 305), an example of which is illustrated in FIG. 7.

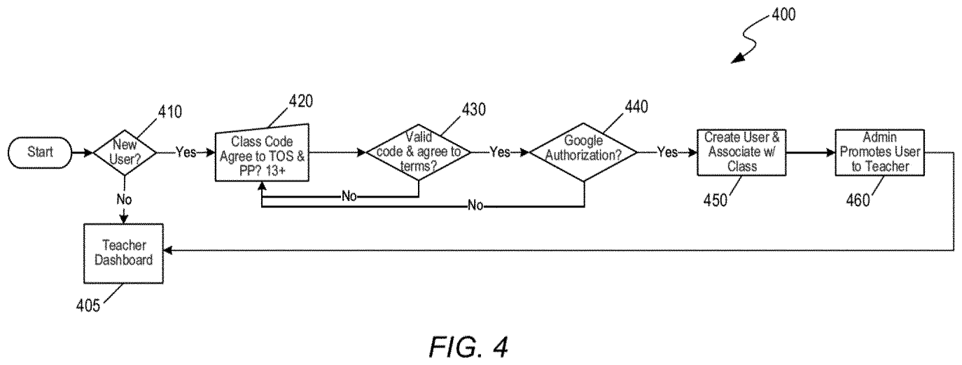

FIG. 4 illustrates a flow chart 400 describing the process of logging a teacher user in or creating a teacher user account. As illustrated therein, the process begins with determining whether the teacher user is a new user (operation 410). If the teacher user is a new user, the teacher needs to create an account, whereas a teacher who is an existing user simply needs to sign in. FIG. 5 shows an example of a user login and user account creation page. If the teacher user is not a new user, the user can simply login to their existing account using the “Sign In” button shown in FIG. 5. If the user needs to create an account, the process will guide them through that process. To create an account, a teacher user will first need to enter a class code, an example of which is shown in FIG. 6. The class code will inform the system which class group to associate the user with (operation 420).

Once the user enters a class code, the process validates the code and may require the user to agree to the terms of use or other policies for using the system (operation 430), an example of which is illustrated in FIG. 6. As shown in FIG. 6, the process may also prompt the user to create an account by signing in with a pre-existing account from another platform, such as a Google account (operation 440). The teacher account is then created associated with the appropriate class (operation 450) based on the class code that was previously entered, and a system administrator promotes the account to a teacher account (operation 460). Finally, the teacher (having either created an account or logged into an existing one) is then taken to a teacher dashboard (operation 405).

In some embodiments, the promotion of an account to a teacher account (operation 460) may be replaced with teachers being able to self-register (with the appropriate credentials) for a teacher account, and create their own class.

FIG. 7 illustrates a first-time student user's individualized dashboard page. As shown therein, the dashboard may contain links to show the student's own projects in which they are a team member. If the student does not currently belong to any team projects, the process may prompt the student to create a project. The dashboard may also contain links to projects other student teams in the student user's class are working on and links to learning materials on social good innovation and design thinking, as illustrated in FIG. 7.

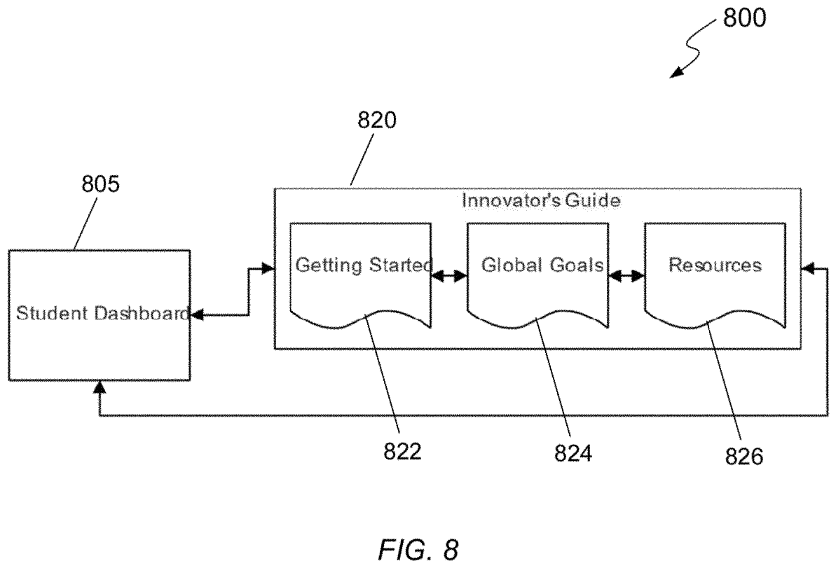

FIG. 8 illustrates a flow chart diagram 800 describing how a student user may interact with an example Innovator's Guide from the dashboard. As illustrated therein, the student can move back and forth between the dashboard (805) and the “Innovator's Guide” (820), which provides learning materials on social good innovation and design thinking. The example of the Innovator's Guide illustrated in FIG. 8 can enable a student user to start a project (e.g., “Getting Started (822)), review the organizational goals associated with the social good innovation (e.g., “Global Goals” (824)), and provide access to resources (e.g., “Resources” (826)).

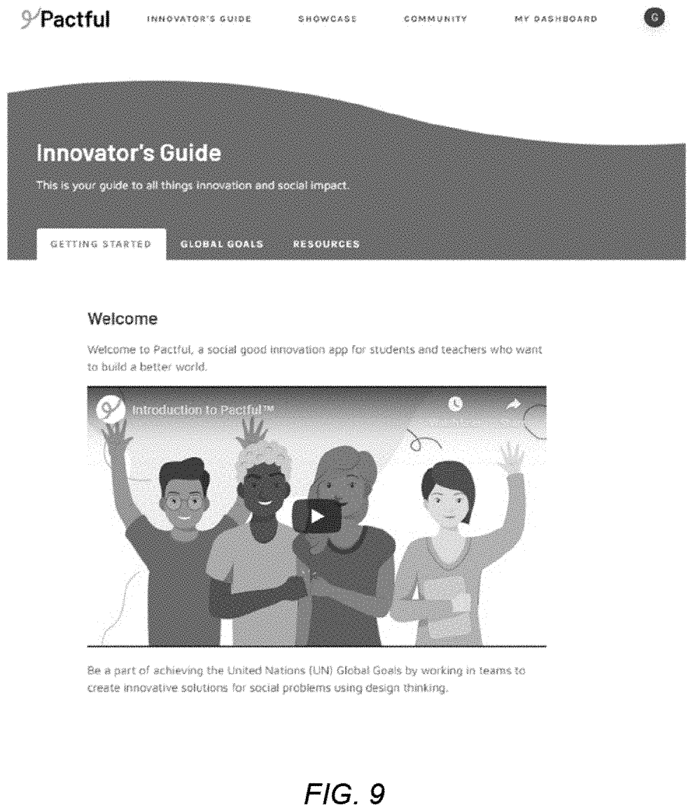

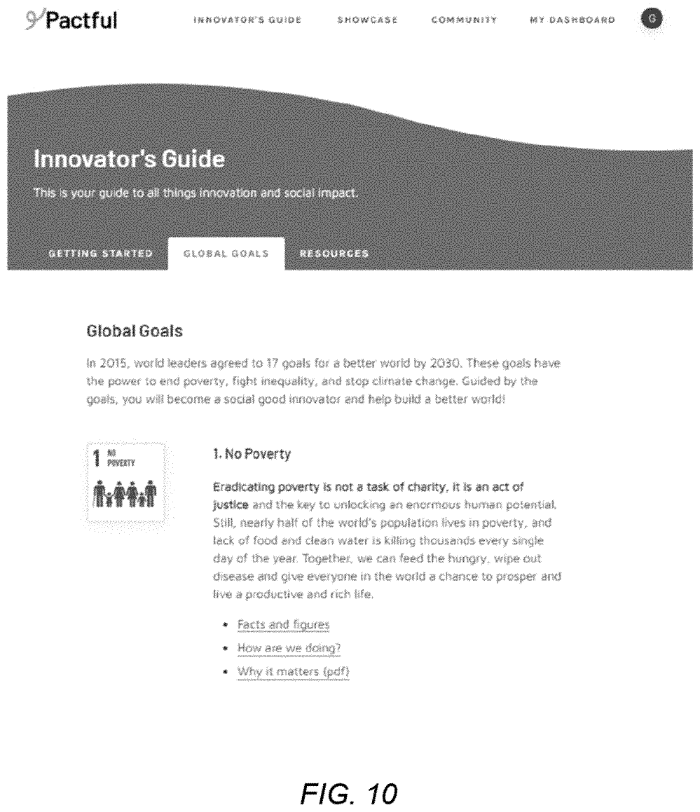

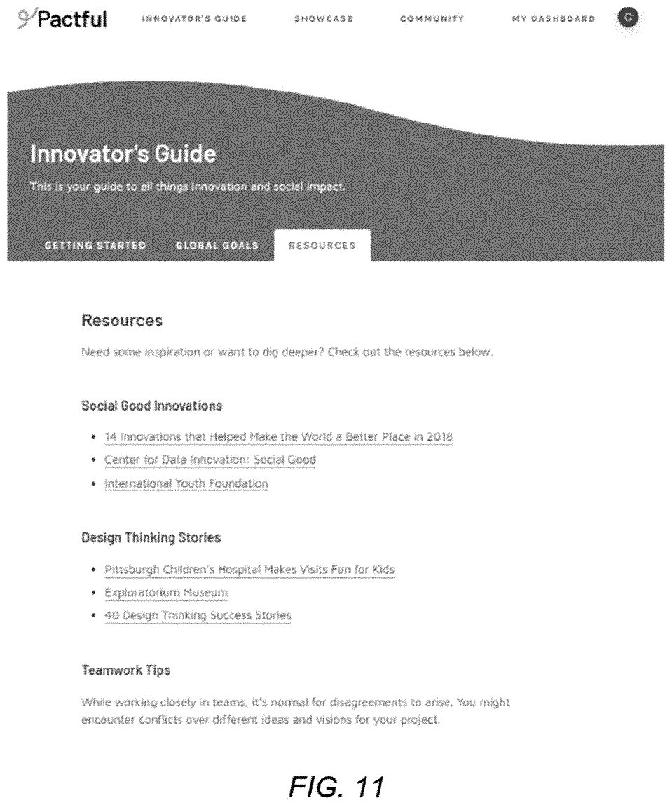

FIG. 9 shows an example of the main page for the Innovator's Guide. As illustrated in FIG. 9, the learning materials may include materials introducing the user to the process or various software-implemented steps, the UN SDGs or other organizational goals, social good innovation, and design thinking. As shown in FIGS. 10 and 11, the learning materials may also include more detailed information on the SDGs or links to external resources on the topics addressed by the software. As indicated by the black arrows in FIG. 8, the student user immediately has access to all of the Innovator's Guide and can choose to access any portion of the Innovator's Guide at any time and in any order the student chooses.

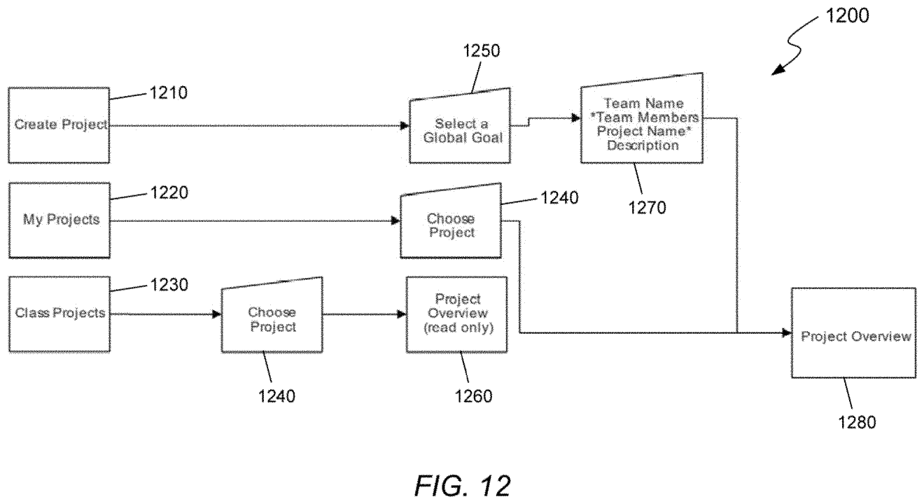

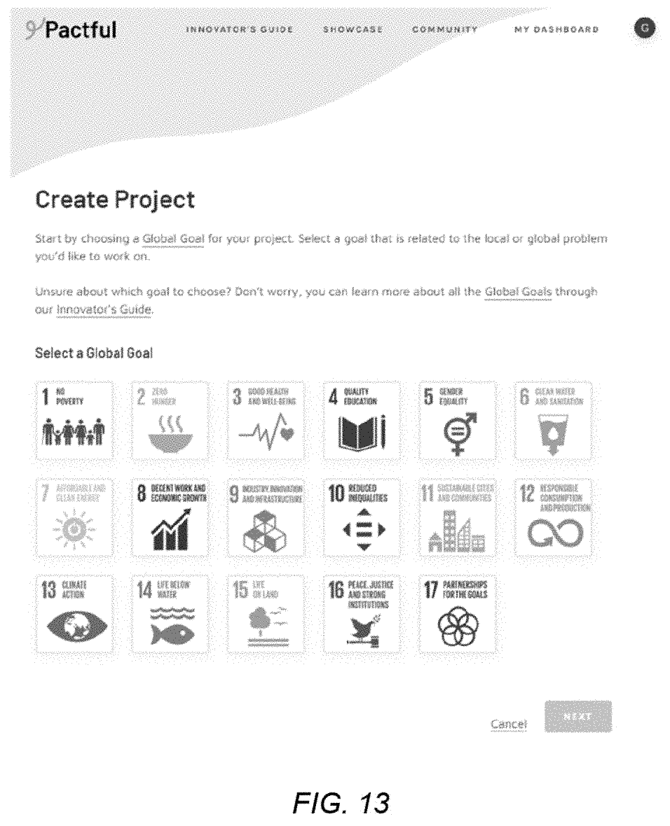

If a student user has not previously created any projects, the student dashboard enables the user to do so (e.g., as illustrated in FIG. 7). Once the student user chooses to create a project, the process will guide the user through the steps to create a project. FIG. 12 illustrates a flow chart diagram describing the project creation process. In an example, the process may prompt the student to create a project (operation 1210) and associate the project with a key social issue (operation 1250)—for example one of the seventeen SDGs—as shown in the example in FIG. 13. This provides the feature and benefit of allowing the student to personalize their learning by allowing the student to choose which goals they want to work toward solving.

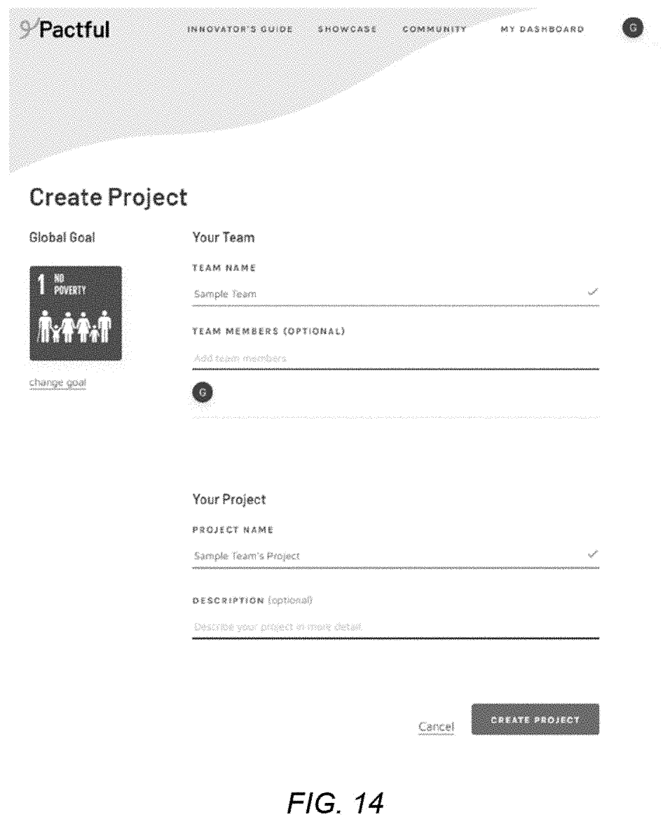

The user is then prompted to enter information identifying the name of the project, the team members who will work on the project, the project name, and the project description, as illustrated in the example in FIG. 14. One feature and benefit of this software-implemented process is its ability to personalize learning and innovation to each student by allowing the students to form their own teams and define the scope of their project. As shown in FIG. 14, the process does not require a teacher account to add students to a team, and the students can do so on their own. The student also can determine the scope and description of the project. This enables students to personalize their team size and composition as well as their project scope to fit their own innovation intentions.

In another example, and as illustrated in FIG. 12, the student user can also access projects the user has previously created (operation 1220) and choose one of those projects (operation 1240). In yet another example, the student user can access projects created by other teams in the student user's class (operation 1230), but will only be able to view, not edit, projects created by other teams in the student user's class that the student user is not a team member of (e.g., read-only mode (operation 1260)).

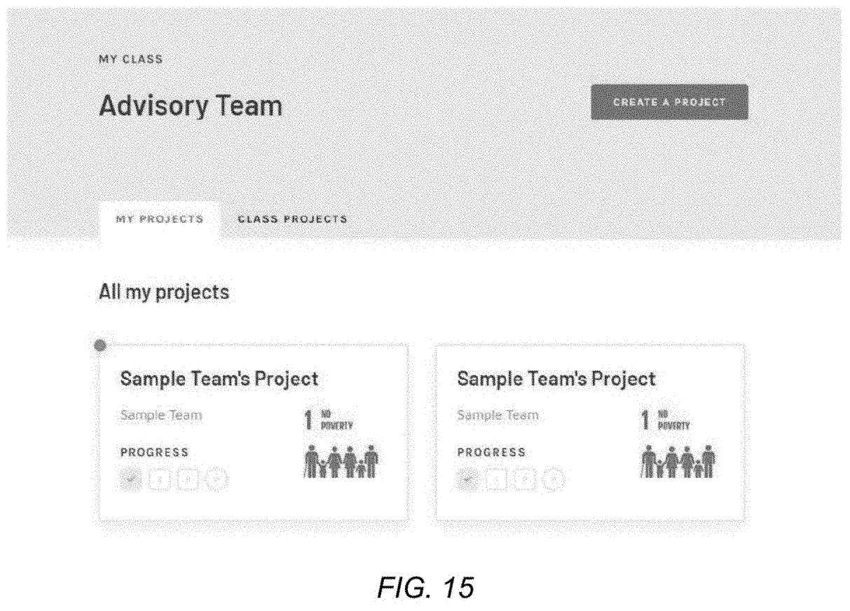

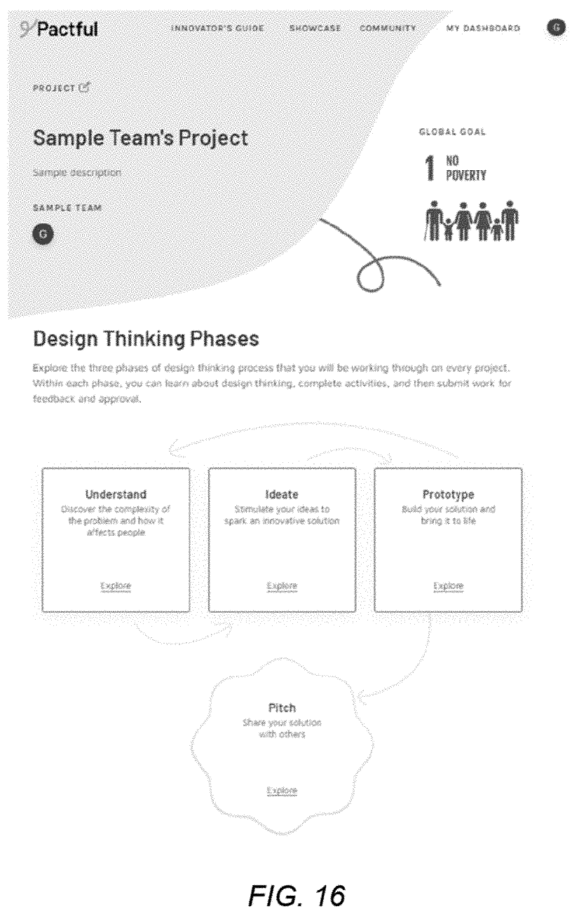

Once the student user has created a project, or opened an existing project, the homepage of each of the student users on the project team can display a link to the project (operation 1280 in FIG. 12), as illustrated in the example in FIG. 15. Student users who are members of the student team associated with the project can access the project's home page via a software portal, such as the one illustrated in FIG. 16.

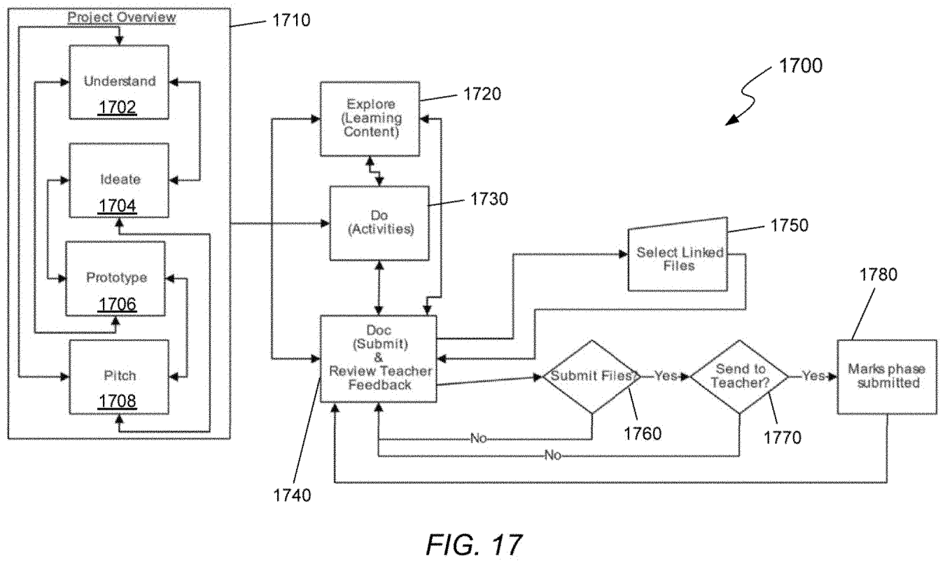

In some embodiments, illustrated in FIG. 16, each project includes four phases of work: “Understand”, “Ideate”, “Prototype”, and “Pitch”. FIG. 17 illustrates a flow chart diagram showing the student user's interaction with each of these phases and each phase's associated steps. The four phases provide a systematic and organized approach, and facilitate a customized methodology for design thinking and innovation that is tailored to social good innovation. The process allows the student team to select any of the phases, in any given order and at any time, as indicated by the arrows in FIG. 17 within the Project Overview (1710).

If an initial selection or sequence of selected phases result in a failure, the user can reselect and re-enter a desired phase (or phases) and spend as much, or as little time, to iterate on aspects contained within the selected phase. This process can be repeated as many times as the student team wants and carried out at any pace. These features of the process are enabled in-part by representing the four phases using four entry points on the student's project home page, one example of which is shown in FIG. 16. As noted above, one feature and benefit of this process is that it enables students to innovate and learn in a non-linear manner. A student team immediately has access to all three phases of design thinking and the subsequent pitch phase and can choose to access any phase at any time and in any order the student or student team choses. The arrows in FIG. 16 display this non-linearity and encourage student teams to proceed to whichever phase they want. The arrows in FIG. 17 also display this non-linearity. Another feature and benefit of the process is that it enables students to personalize their innovation's focus. The process allows each student team to choose to start at whatever phase of the design thinking and innovation process they choose, enabling the student and student team to personalize the order in which they learn and work on the design phases.

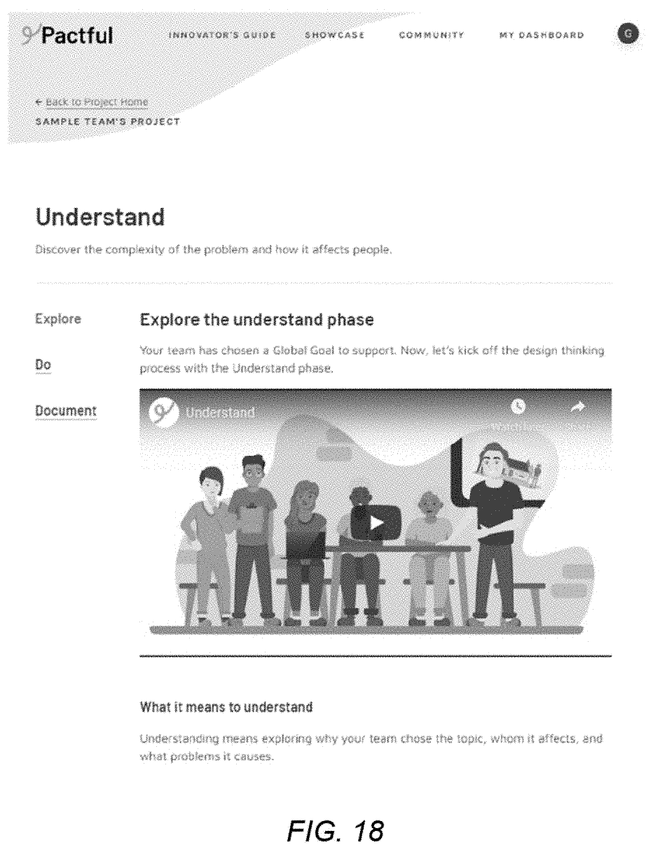

A student user can access each of the design thinking and innovation phases by clicking on the respective icon on the home page shown in FIG. 16. From there, the process takes the student user to the page for the respective phase. For example, clicking on the “Understand” box takes the user to a more detailed screen, as shown in FIG. 18. As is shown in FIG. 17, the process further breaks down each phase page into three steps: “Explore”, “Do”, and “Document”. This is yet another feature of the disclosed embodiments: the process provides systematic and organized approach that facilitates the design innovation process while also enabling the students to innovate and learn in a non-linear manner. In particular, a student user immediately has access to all steps of the three phases, and can choose to access any step at any time and in any order the student choses, as shown by the arrows in FIG. 17. Another feature and benefit of the process is that it enables students to personalize their learning and their innovation work. The process allows each individual student to choose to start at whichever step of the phase the student chooses, enabling the student to personalize the order in which they work through the steps.

FIG. 18 illustrates an example of the “Explore” step page of the “Understand” phase. In each phase's “Explore” step, the process provides the student user with content to teach the student about the respective phase. The content can be custom created curriculum content or content curated from other open sources. In an example, a backend content management system populates the software pages with curriculum, enabling an administrator of the site to update or add content to the page if desired. A feature and benefit of this process is that it enables students to innovate and learn in a non-linear manner. A student user immediately has access to the entirety of the “Explore” step and may choose to access any learning content at any time and in any order. Another feature and benefit of the process is that it enables students to personalize their innovation and learning. The process allows each individual student to choose to interact with whichever curriculum content the student chooses, without requiring each student to interact with the same curriculum content.

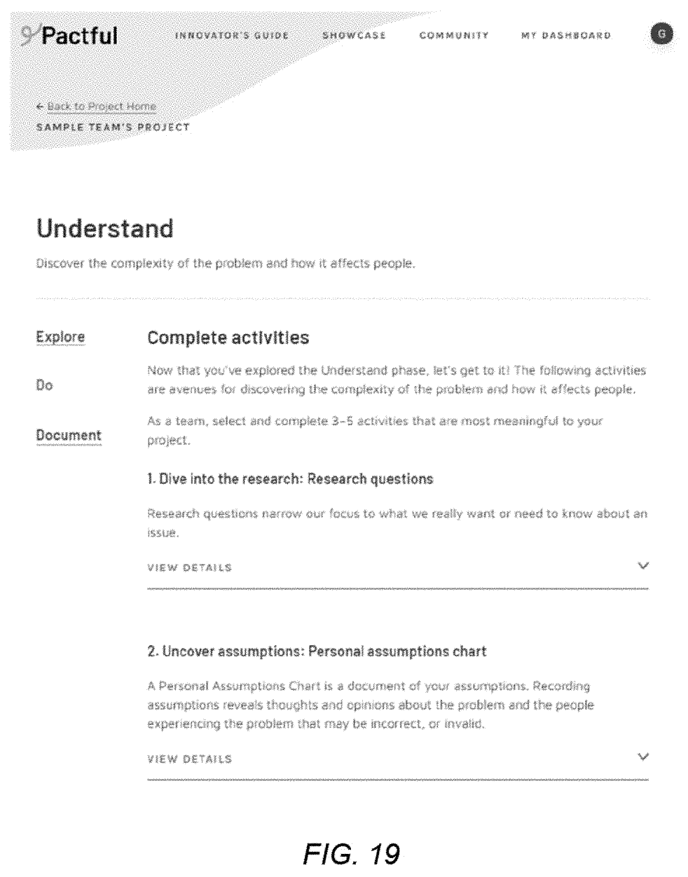

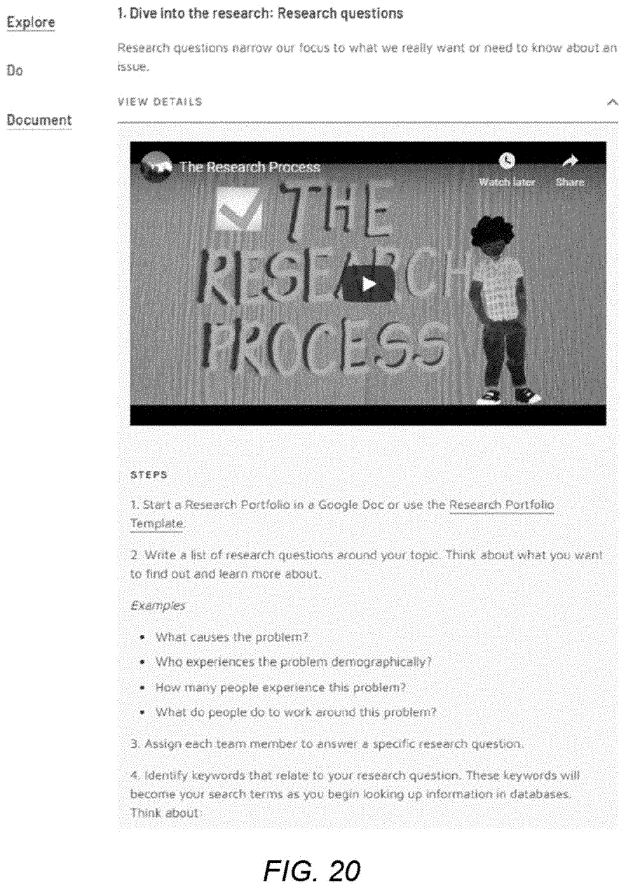

FIG. 19 illustrates an example of the “Do” step page of the “Understand” phase. In each phase's “Do” step, the software provides the student user with activities for the student to do to teach the student about the respective phase and have the student progress on their project. The process provides instructions for completing each activity in the “Do” step, as illustrated in FIG. 20. A feature and benefit of this process is that it enables students to learn and innovate in a non-linear manner. A student user immediately has access to all the activities on the “Do” step and may choose to do any activities at any time and in any order. Another feature and benefit of the process is that it enables students to personalize their learning and their innovation work. The process allows each individual student to choose which activities to do, without requiring each student to complete the same activities. This enables students to do the activities that the student finds most engaging or that are most relevant to the student's project.

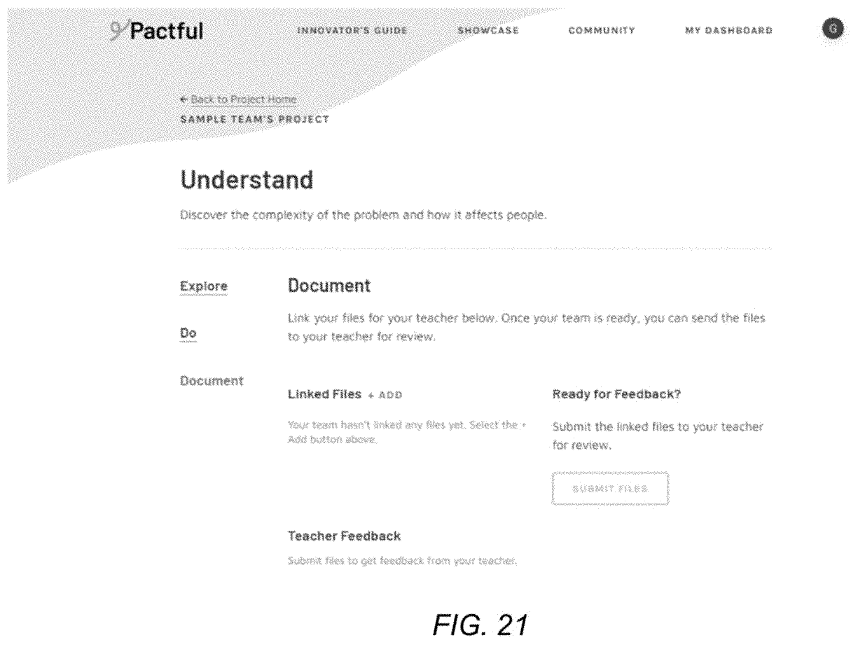

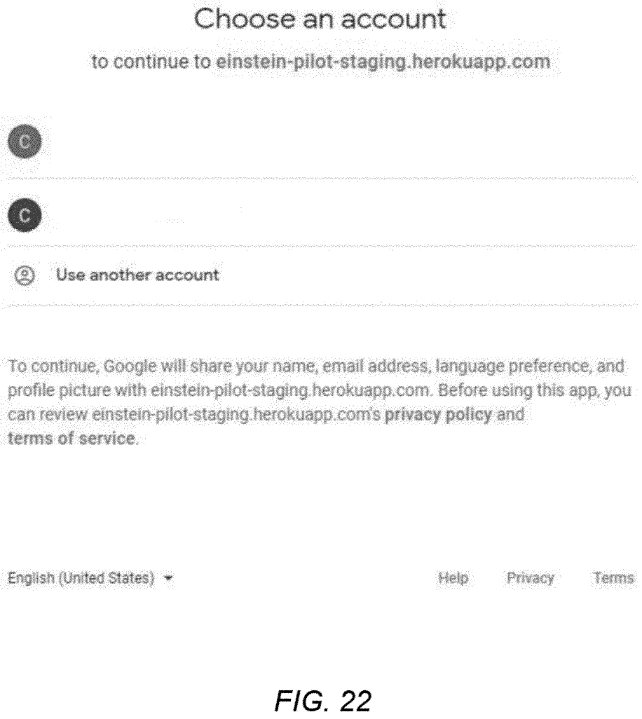

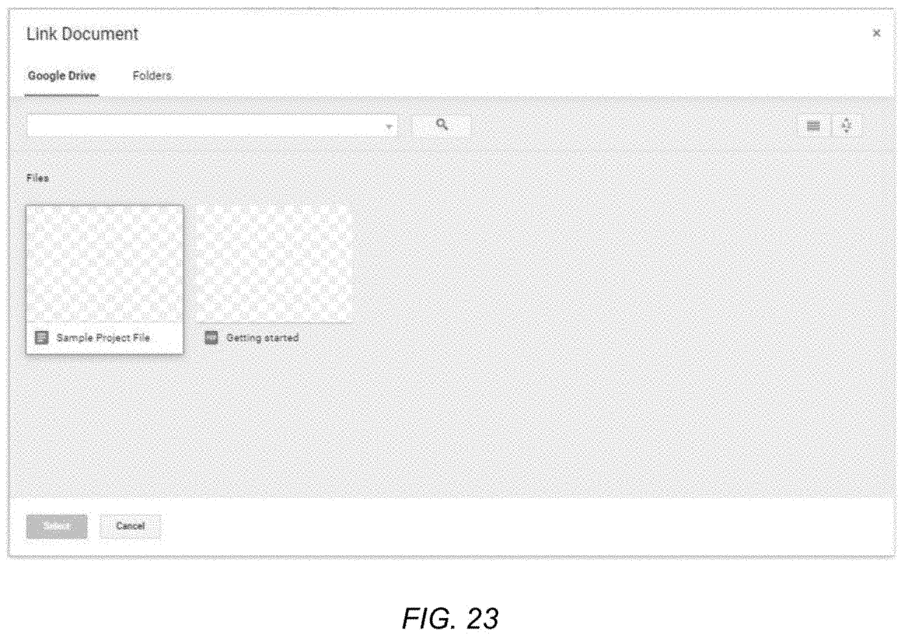

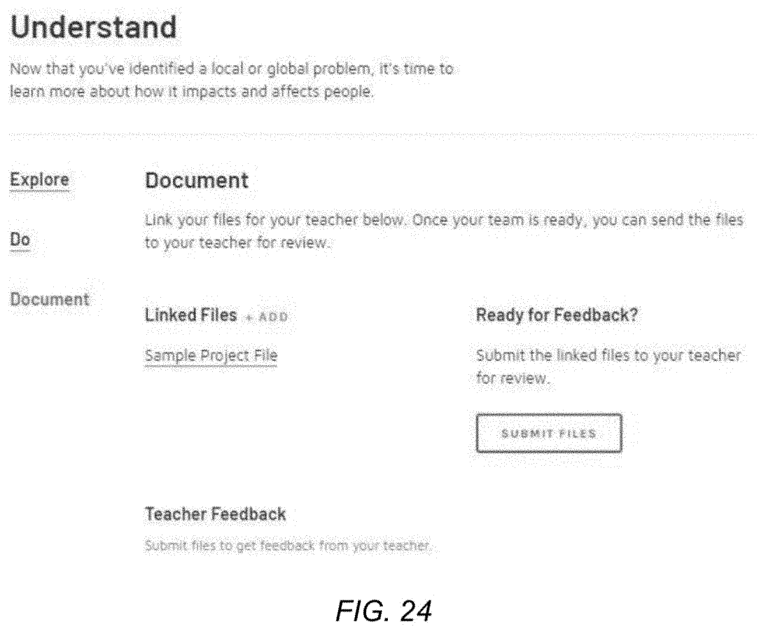

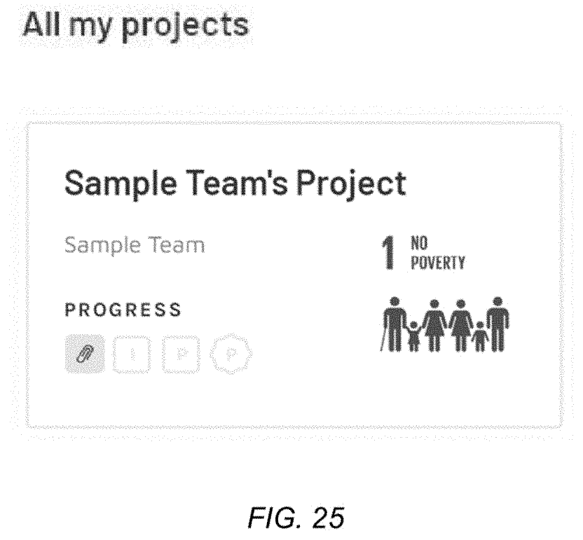

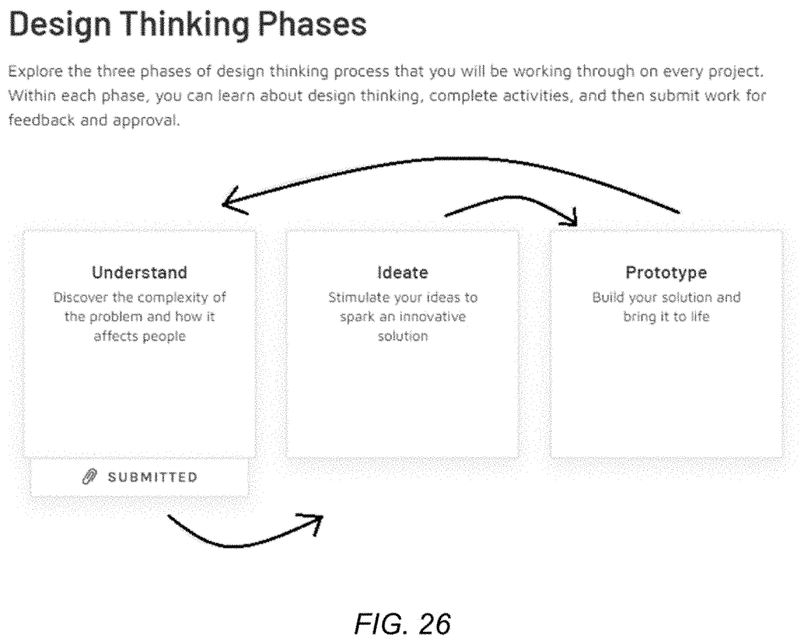

FIG. 21 displays the “Document” step page of the “Understand” phase. In each phase's “Document” step, the process enables the student to link files from other sources, such as document sharing sites like Google Drive or Google Docs. The student team should have completed various types of files during the “Do” step of the phase. Once the student team has worked on some number of documents, the student team can link to those documents using the “+Add” link shown in FIG. 21. The process will then prompt the student to give access to the relevant document sharing site, such as Google Drive or Google Docs, as shown in FIG. 22. Once the student has provided the system with access to the relevant document sharing site, the user can select which documents to link to the project, as shown in FIG. 23 and the flow chart diagram in FIG. 17. Once a user has linked a document, the process will show the student team which files have been linked, as shown in FIG. 24. The user can then click on the “Submit Files” button shown in FIG. 24 to submit linked files to a teacher user for the teacher to review and give feedback, as is shown in the flow chart diagram in FIG. 17. Once a student team has submitted documents for review, the process provides indicators of the student team's status in the phase the student team has submitted documents for, as shown in FIGS. 25 and 26, and the flow chart diagram in FIG. 17. In an example, the “submitted” status is represented using a paper clip icon.

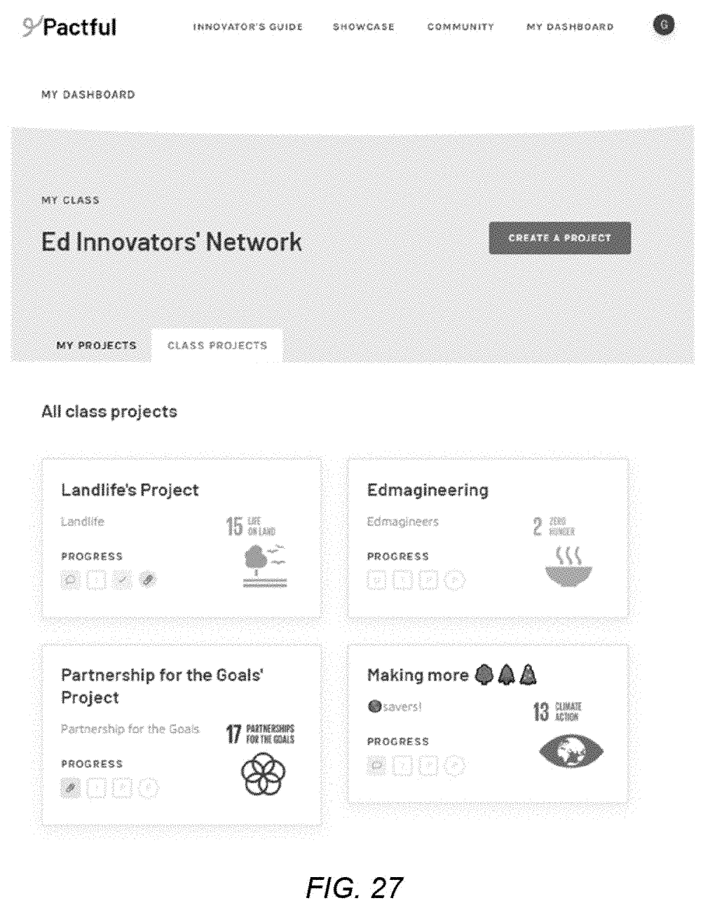

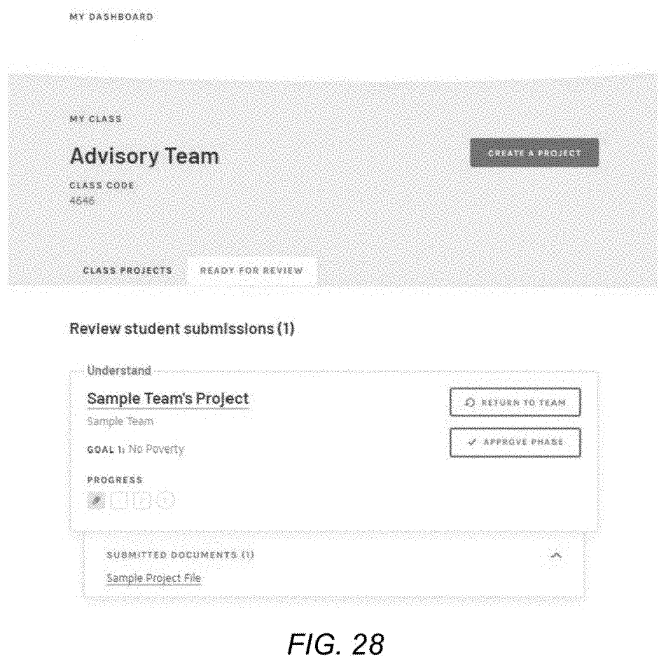

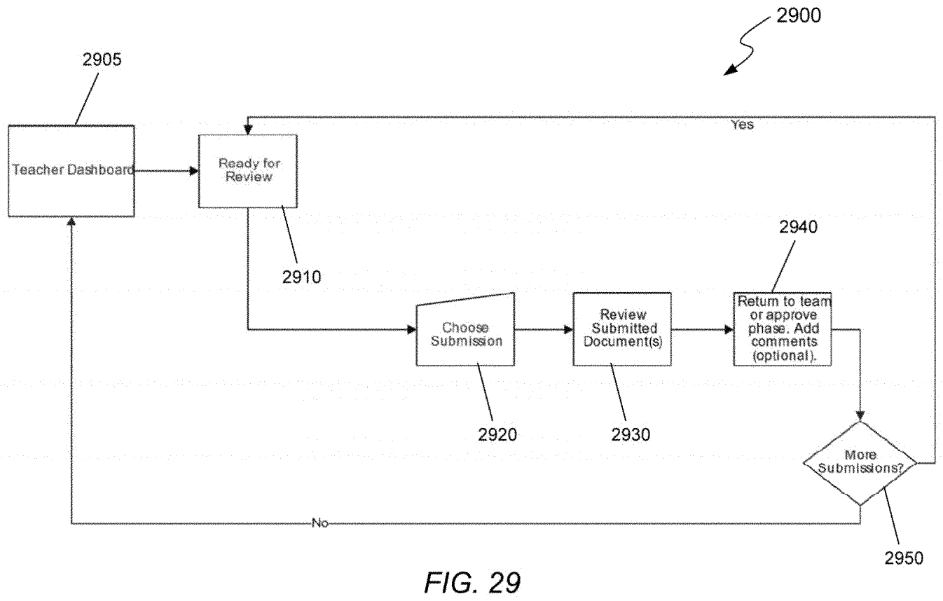

Once a student team has submitted documents to a teacher for review, the process indicates to the teacher that there are documents for the teacher to review via a notification in both the “Class Projects” tab and “Ready For Review” tab of the teacher's dashboard, as shown in FIGS. 27 and 28. The process enables the teacher to see all the student teams' projects in the “Class Projects” tab and just those projects with documents submitted for review in the “Ready For Review” tab. FIG. 29 illustrates a flow chart diagram showing the process by which a teacher user can use the “Ready For Review” page (2910) to review documents submitted by student teams, which can be accessed through the teacher dashboard (2905). In the “Ready For Review” tab the process enables the teacher to first choose a submission (operation 2920), review the submitted documents (operation 2930), and then either return the documents to the student team with feedback (operation 2940) or approve the student teams' work for the respective phase as shown in FIG. 28. As is shown in FIG. 29, once the teacher user has reviewed one set of submitted documents, the teacher user can either return to the teacher dashboard shown in FIG. 27 or review further submissions (operation 2950).

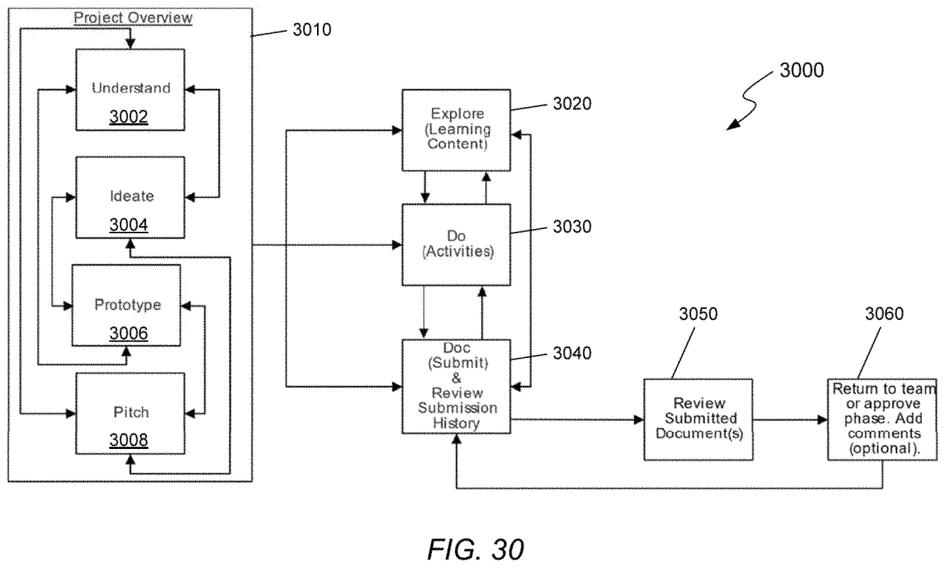

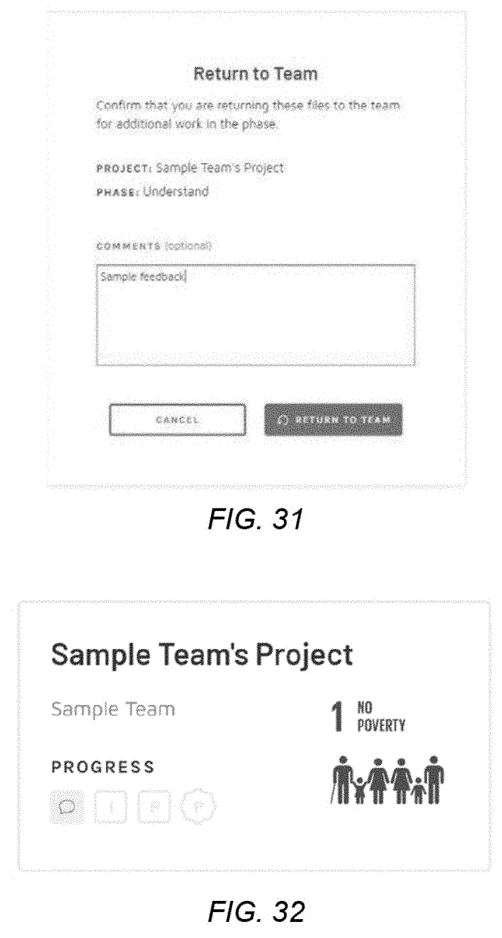

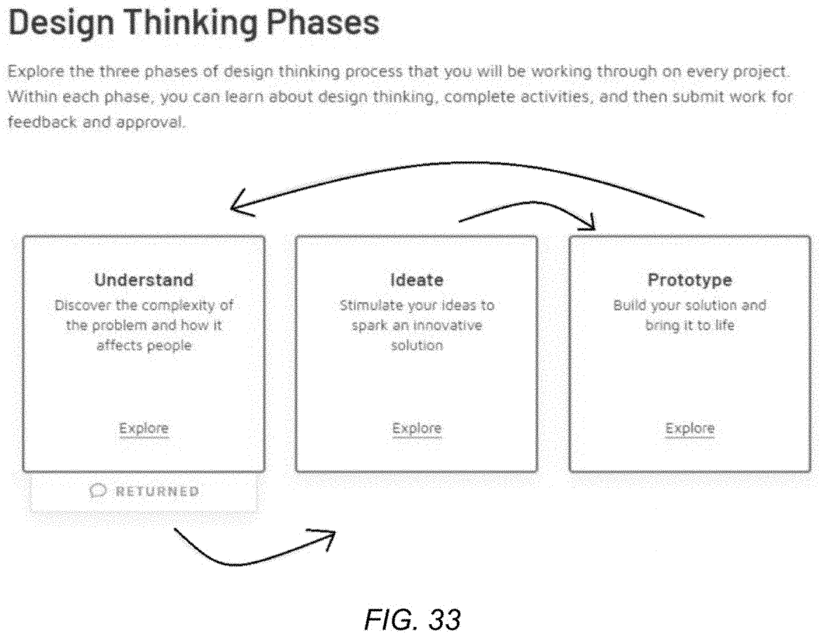

FIG. 30 illustrates a flow chart diagram showing the process by which a teacher user can review student teams' documents. Similar to the flow diagram described in FIG. 17, each of the four phases (e.g., Understand 3002, Ideate 3004, Prototype 3006, Pitch 3008) illustrated in FIG. 30 can be accessed in a non-linear manner, and wherein the three steps (e.g., Explore 3020, Do 3030, Document 3040) of each phase are always available and can also be accessed in any order. In this embodiments, the Document step (3040) includes reviewing the submission history. The teacher user reviews the submitted documents (3050) and chooses to either return the documents to the student team or approve the documents (3060). If a teacher chooses to return the student team's work, the process will prompt the teacher to provide feedback to the student team on their work, as shown in FIG. 31. Once the teacher has submitted feedback, the process will notify everyone on the student team that they have received feedback, as shown in FIGS. 32 and 33. In an example, the “returned” status is represented using a speech balloon icon.

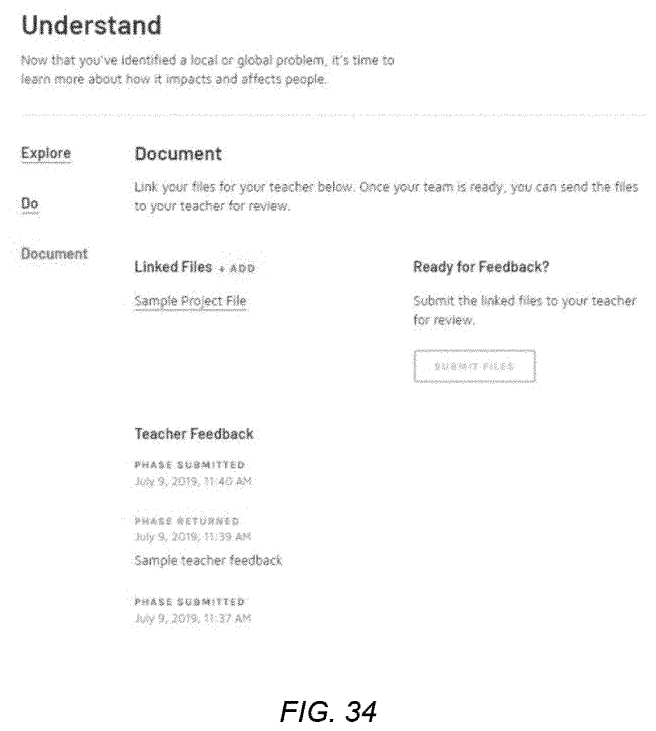

In some embodiments, the process enables the students individually to view the teacher's feedback on the “Document” step of the respective phase, as illustrated in FIG. 34. As seen therein, the process enables the “Document” step of each phase to track the documents the student team has submitted, as well as the feedback or approvals the student team has received from the teacher.

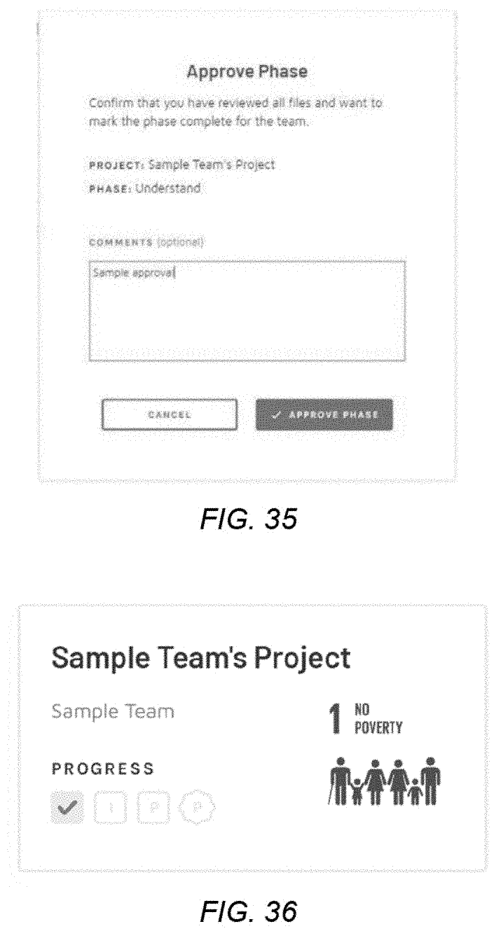

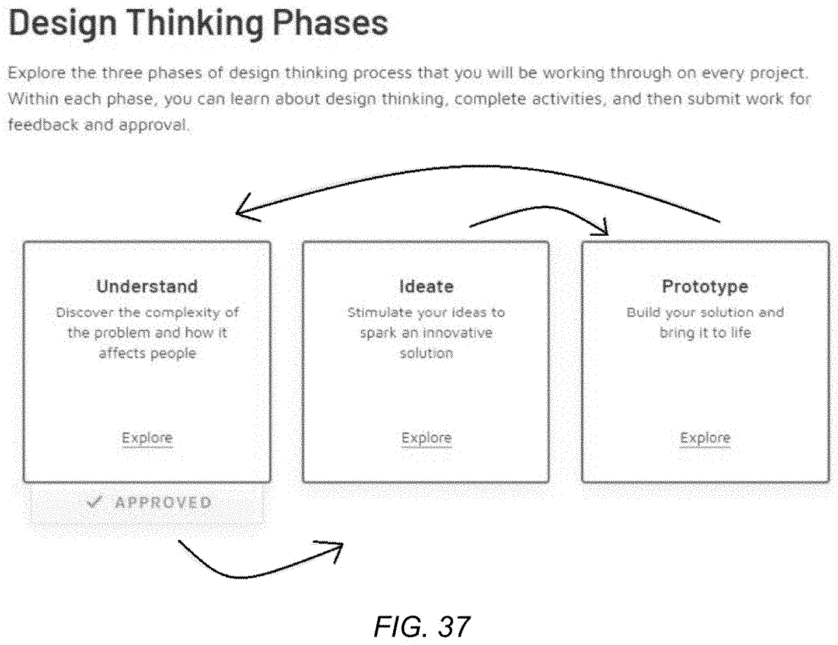

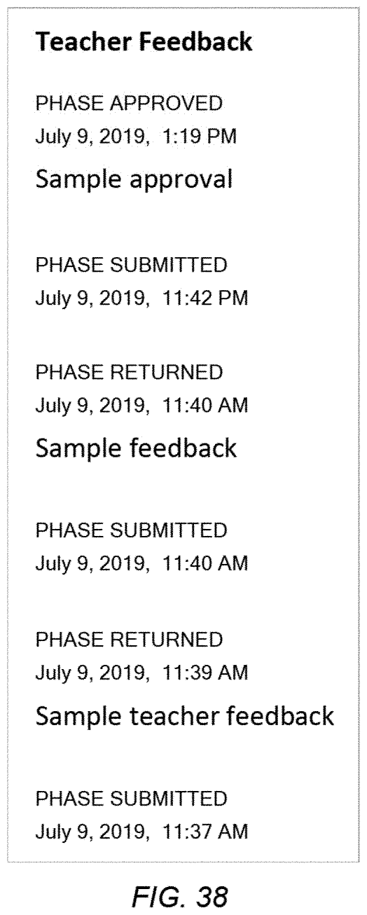

If a teacher chooses to approve the student team's work, the process prompts the teacher to provide feedback to the student team with the approval, as shown in FIG. 35. Once the teacher has submitted the approval, the process notifies everyone on the student team that the work was approved, as shown in FIGS. 36 and 37. The process enables the students to individually view the teacher's approval on the “Document” step of the approved phase, as shown in FIG. 38.

As noted earlier, the disclosed systematic document submission, feedback, and approval functionalities enable students to learn and innovate in a non-linear manner. A student team can submit documents at any time and in any order and can submit unfinished documents for review. This enables teachers to give feedback to the student team over the course of the student team's work on the project and enables the student team to iterate on their work without requiring that student teams start work and reach a specified completion point by a specified deadline. Another feature and benefit of the disclosed processes relates to enabling students to personalize their learning and their innovation work. The process allows the teacher to provide each student team individualized feedback on their work and enables student teams to receive individualized learning from their teacher. The disclosed process allows different students and student teams to reach different milestones in their innovation projects at different times by allowing teachers to approve different student teams' work at different times without any penalty to student teams.

In some embodiments, the teacher can also review web analytics information for each student in a team to ascertain the contribution of each student. In an example, a web analytics service (e.g., Google Analytics, a proprietary analytics solutions, etc.) may be supported by the educational software platform and configured to track session duration (e.g., time spent on a particular page, pages per session), the external resources accessed by a particular student and for what length of time that resource was used. This further enables the teacher to guide students toward their own milestones.

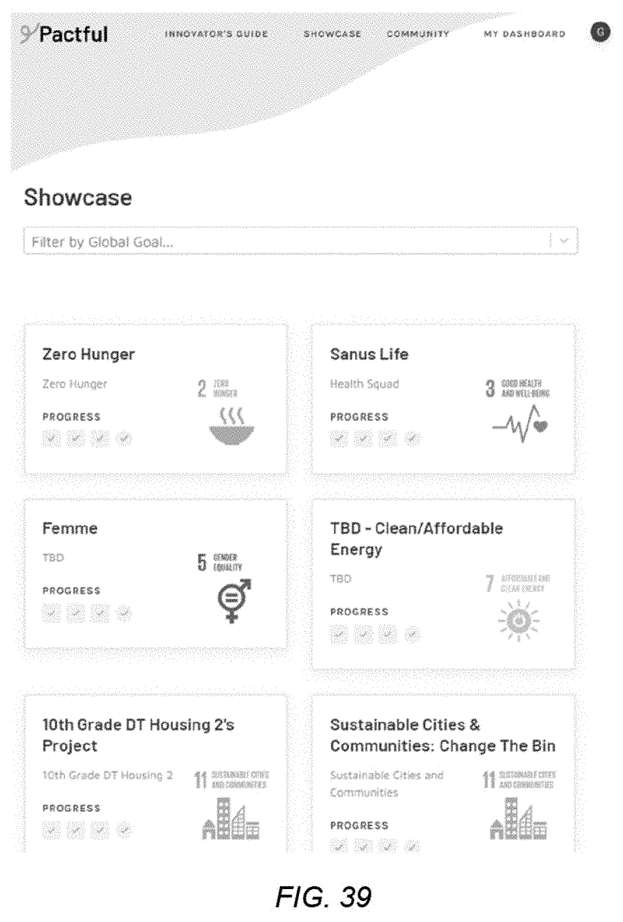

Example embodiments of the educational software platform described herein can further support a showcase functionality, as illustrated in FIG. 39. In some embodiments, as soon as a project is created, it is automatically available in the showcase. The showcase sorts projects by phases completed, so projects that have all four phases submitted and approved by their teacher will appear first, with newly created projects appearing at the bottom. The showcase can filter the list of projects on a specific global or organizational goal, so viewers can see other projects that are completed or in progress, aligned to a specific global or organizational goal.

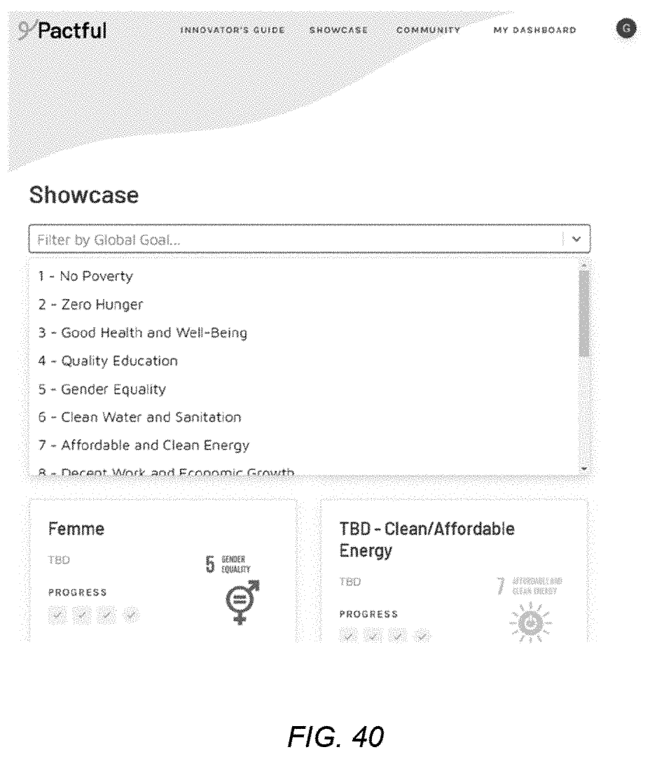

In an example, each project and/or solution can be tagged with keywords that are representative of one or more goals that the project and solution are targeting. Thus, a student user or a teacher user can select a goal and view all the projects associated with that particular goal. In the example illustrated in FIG. 40, the user can use the showcase functionality to filter by global goal, and subsequently view a list of projects and solutions that have been developed to meet the selected global goal. In another example, projects and/or solutions can be searched based on specific keywords.

In some embodiments, the showcase can be configured to highlight in-progress projects and projects looking for members so that students could review open projects and “join” them if that particular project is of interest to them.

In some embodiments, the showcase makes both a project and all corresponding solutions available so that a larger group of researchers, participants, or the public can mine the data associated with and/or review completed or in-progress projects. The availability of projects and solutions aligned to a global or organization goal can be leveraged for commercialization, collaborative future development, or incorporation into policy decisions.

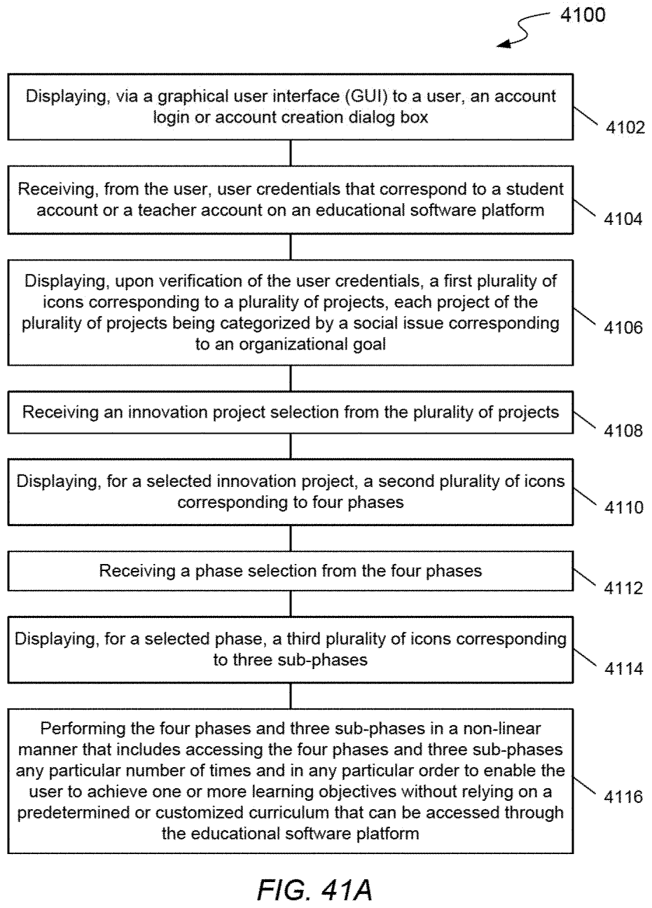

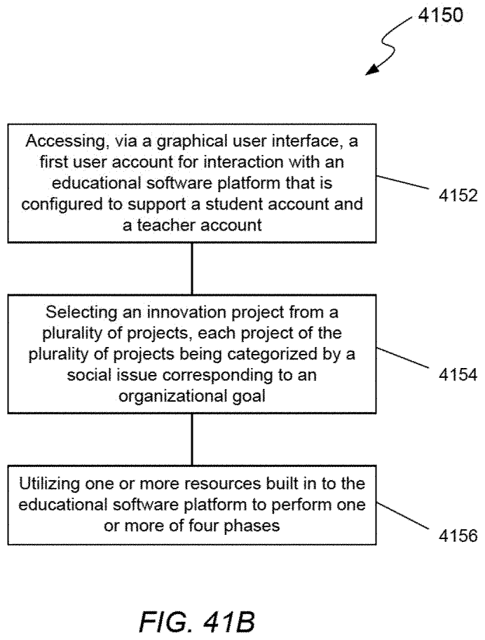

FIG. 41A is an example of a method flowchart for non-linear and collaborative on-line management of a project. The method 4100 includes, at operation 4102, displaying, via a graphical user interface (GUI) to a user, an account login or account creation dialog box.

The method 4100 includes, at operation 4104, receiving, from the user, user credentials that correspond to a student account or a teacher account on an educational software platform.

The method 4100 includes, at operation 4106, displaying, upon verification of the user credentials, a first plurality of icons corresponding to a plurality of projects, each project of the plurality of projects being categorized by a social issue corresponding to an organizational goal.

The method 4100 includes, at operation 4108, receiving an innovation project selection from the plurality of projects.

The method 4100 includes, at operation 4110, displaying, for a selected innovation project, a second plurality of icons corresponding to four phases. In some embodiments, the four phases include (a) an understanding phase related to understanding the complexity of a problem corresponding to the social issue and how it affects people, (b) an ideation phase related to developing ideas and potential solutions to the problem using one or more collaboration tools built into the educational software platform, (c) a prototyping phase related to producing a prototype associated with the selected innovation project based on the ideas and potential solutions, and (d) a pitch phase related to developing a presentation associated with the selected innovation project that highlights the prototype.

The method 4100 includes, at operation 4112, receiving a phase selection from the four phases.

The method 4100 includes, at operation 4114, displaying, for a selected phase, a third plurality of icons corresponding to three steps. In some embodiments, the three steps include (i) an exploration step configured to provide the user with information and resources related to the selected innovation project and the social issue, (ii) an activity step configured to enable the user to perform one or more of a plurality of activities related to the selected innovation project, and (iii) a documentation step configured to enable the user to link one or more documents to the selected innovation project.

The method 4100 includes, at operation 4116, performing the four phases and three steps in a non-linear manner that includes accessing the four phases and three steps any particular number of times and in any particular order to enable the user to achieve one or more learning objectives without relying on a predetermined or customized curriculum that can be accessed through the educational software platform.

In some embodiments, the organizational goal comprises a United Nations (UN) Sustainable Development Goal (SDG) that is automatically linked to the educational software platform.

In some embodiments, the user is a student user, and the educational software platform comprises one or more collaboration tools that enable the user to identify one or more other students without input from the teacher account.

FIG. 41B is another example of a method flowchart for non-linear and collaborative on-line management of a project. The method 4150 includes, at operation 4152, accessing, via a graphical user interface, a first user account for interaction with an educational software platform that is configured to support a student account and a teacher account.

The method 4150 includes, at operation 4154, selecting an innovation project from a plurality of projects, each project of the plurality of projects being categorized by a social issue corresponding to an organizational goal. In other embodiments, operation 4154 includes creating an innovation project that is categorized by a social issue corresponding to an organizational goal. In an example, the newly created innovation project may be modeled on an existing project or uses a template associated with a predetermined social goal. In another example, the newly created innovation project can be manually configured to achieve the objectives of the user.

The method 4150 includes, at operation 4156, utilizing one or more resources built into the educational software platform to perform one or more of four phases. In some embodiments, the four phases include (a) an understanding phase related to understanding a complexity of a problem corresponding to the social issue and how it affects people, (b) an ideation phase related to developing ideas and potential solutions to the problem using one or more collaboration tools built into the educational software platform, (c) a prototyping phase related to producing a prototype associated with the innovation project based on the ideas and potential solutions, and (d) a pitch phase related to developing a presentation associated with the innovation project that highlights the prototype. In other embodiments, a presentation developed in the pitch phase may highlight other accomplishments of the innovation project that exclude the prototype, which may still be under development.

In some embodiments, performing the one or more of the four phases includes performing the phases (a), (b), and (c) in a non-linear manner that includes accessing the phases (a), (b), and (c) any particular number of times and in any particular order to enable a user of the first user account to achieve one or more learning objectives without relying on a predetermined or customized curriculum that can be accessed through the educational software platform. In an example, and based on leveraging the non-linear approach, any one of the phases (a), (b), (c) or (d) may be performed individually and independently from the other phases.

According to some embodiments, the non-linear approach can be leveraged to only perform the Pitch phase (e.g., phase (d)) that focuses on a potential solution to a social goal. In an example, the pitch of the potential solution may include descriptions of improvements to a methodology that was previously developed (e.g., thereby circumventing phases (a) and (b)) and does not include a prototype (e.g., therein skipping phase (c)). In another example, the pitch uses the educational software platform to present the potential solution. In yet another example, the pitch can be presented using a third-party platform.

In some embodiments, the one or more resources comprise the one or more collaboration tools enabling information sharing between a plurality of student accounts and a review tool enabling two-way interaction between the teacher account and the student account. In other embodiments, one or more students can invite other team members to the project to use the one or more collaboration tools so the team can work together on the project.

In some embodiments, the first user account is selected from a group consisting of the student account, the teacher account, and an administrator account.

In some embodiments, the organizational goal comprises a United Nations (UN) Sustainable Development Goal (SDG) that is automatically linked to the educational software platform.

In some embodiments, the first user account is the student account, and the one or more collaboration tools enables the first user account to identify one or more other student accounts without input from the teacher account.

In some embodiments, each of the four phases is accessible via the graphical user interface that simultaneously displays corresponding icons for each of the four phases.

In some embodiments, each of the four phases is systematically divided into three steps: (1) explore, (2) do, and (3) document, which can be accessed via the graphical user interface upon selection of a particular one of the four phases.

In some embodiments, each of the four phases and each of three steps associated with each phase can be accessed in any particular order to enable a non-linear innovation process.

In some embodiments, the method 4150 further includes accessing, via the graphical user interface, an additional software portal capable of receiving and uploading documents associated with one or more of the plurality of projects from multiple users.

In some embodiments, the method 4150 further includes automatically including an assigned status indicator tag associated with each project to indicate a status of the documents associated with the corresponding project. In an example, documents associated with a particular project are uploaded by multiple students for review by a teacher. Once the review is complete, the teacher can assign a status to the set of documents, which are returned to the students and automatically tagged individually to project each student with a completed, approved, or returned status. Optionally, this may be accompanied by feedback from the teacher.

In some embodiments, the status indicator tag indicates a completed status, an approved status, or a returned status.

In some embodiments, the method 4150 further includes automatically storing, on a periodic basis, the plurality of projects and information generated in any of the four phases in a database coupled to the educational software platform.

In some embodiments, the method 4150 further includes displaying, via the graphical user interface, some or all of the plurality of projects, and using one or more criteria to filter the displayed projects, the one or more criteria comprising the social issue, the organizational goal, a completion status or an in-progress status of any one of the four phases (e.g., as illustrated in FIGS. 39 and 40 using the showcase). In an example, a student or a teacher can filter one or more databases to list all projects, ideas and/or solutions that relate to a social issue or organizational goal. This enables, for example, a student to join a team that aligns with her/his interests.

In some embodiments, the method 4150 further includes configuring, based on the one or more criteria, the educational software platform for access by a second user account that is different from the student account and the teacher account. In an example, this second user account could be a researcher account, a public policy expert account, and a general access account from a public library.

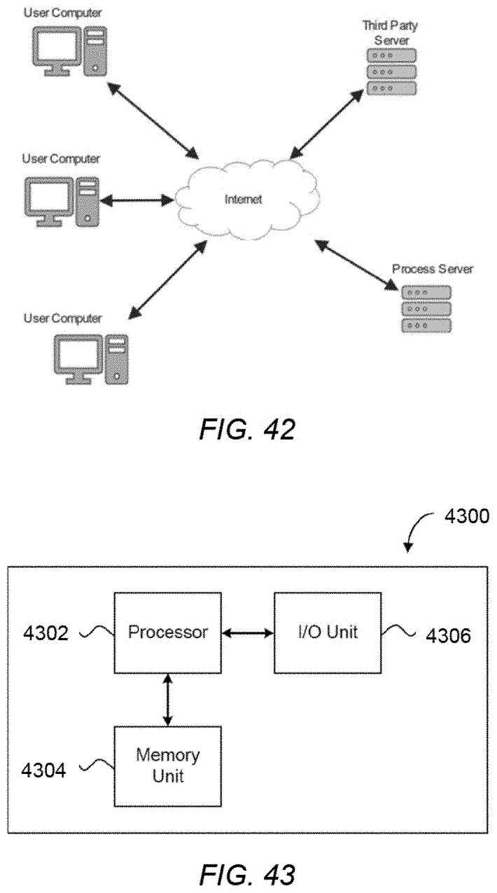

The disclosed embodiment may be implemented over a network of devices, such as the Internet. FIG. 42 illustrates an example implementation of the disclosed embodiment over the internet. A user computer or other network-enabled device communicates with the Internet in order to access the process. The process is nm on one or more servers or other devices communicating with the Internet, as shown in FIG. 42. The user devices and process server may also communicate with third party servers or devices via the Internet to sign a user in via a pre-existing account from a separate service or link documents from a separate document creation service, as described above.

The process may also create a database of all projects created within the process on the process server, or some other separate server. This database enables aggregation of all projects created within the process and the data associated with those projects. This database enables users or other individuals to mine or filter the data related to the aggregation of projects. This can enable users or other individuals to use data about the projects to determine what types of projects have been created, what state those projects are in, and which key social issue those projects are associated with. This database can further enable individuals to use projects which implement solutions to existing problems or can provide a starting point to improve on existing projects to further work towards achieving social goals.

The process may also create an immutable timestamped repository of social good innovation projects and solutions, aligned to goals such as the UN SDGs. An example repository is a blockchain. This repository may be publicly available and would serve as an authority of innovation projects and the inception, progress, and ownership of solutions.

FIG. 43 shows a block diagram of an example embodiment of a device (or apparatus, hardware device or implementation) 4300 that implements the disclosed technology. The device includes a processor 4302 in communication with a memory unit 4304 and an input/output (I/O) unit 4306. The processor 4302 is configured to process data, and the memory unit 4304 is in communication with the processor to store and/or buffer the data. To support various functions of the device, the processor can be included to interface with and control operations of other devices, e.g., via the I/O unit 4306.

In various implementations, the processor 4302 can include one or more processors, e.g., including but not limited to microprocessors such as a central processing unit (CPU), microcontrollers, or the like. The memory unit 4304 can include and store processor-executable code, which when executed by the processor, configures the device to perform various operations, e.g., such as receiving information, commands, and/or data, processing information and data, and transmitting or providing information/data to another device. The memory unit can store other information and data, such as instructions, software, values, images, and other data processed or referenced by processor. For example, various types of Random Access Memory (RAM) devices, Read Only Memory (ROM) devices, Flash Memory devices, and other suitable storage media can be used to implement storage functions of memory unit. In some implementations, the device includes an input/output unit (I/O) 4306 to interface the processor and/or memory unit to other modules, units or devices associated with the system, and/or external devices. For example, the I/O unit can connect to an external interface, source of data storage, or display device. Various types of wired or wireless interfaces compatible with typical data communication standards, such as Universal Serial Bus (USB), IEEE 1394 (FireWire), Bluetooth, Bluetooth low energy (BLE), ZigBee, IEEE 802.11, Wireless Local Area Network (WLAN), Wireless Personal Area Network (WPAN), Wireless Wide Area Network (WWAN), WiMAX, IEEE 802.16 (Worldwide Interoperability for Microwave Access (WiMAX)), 3G/4G/LTE cellular communication methods, and parallel interfaces, can be used to communicate data with the device via the I/O unit. In some implementations, for example, the device 4300 includes a wireless communications unit, e.g., such as a transmitter (Tx) or a transmitter/receiver (Tx/Rx) unit. In such implementations, for example, the I/O unit can interface the processor and memory unit with the wireless communications unit to utilize various types of wireless interfaces, such as the examples described above. The I/O unit can interface with other external interfaces, sources of data storage, and/or visual or audio display devices, etc. to retrieve and transfer data and information that can be processed by the processor, stored in the memory unit, or exhibited on an output unit of a user device (e.g., display screen of a computing device) or an external device.

At least parts of the disclosed embodiments that include modules and the functional operations can be implemented in digital electronic circuitry, or in computer software, firmware, or hardware. At least some of those embodiments or operations can be implemented as one or more computer program products, i.e., one or more modules of computer program instructions encoded on a computer-readable medium for execution by, or to control the operation of, data processing apparatus. The computer-readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of nonvolatile memory, media and memory devices, including by way of example semiconductor memory devices, e.g., EPROM, EEPROM, and flash memory devices. The processor and the memory can be supplemented by, or incorporated in, special purpose logic circuitry.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described, and other implementations, enhancements and variations can be made based on what is described and illustrated in this patent document.

What is claimed is:

1. A computer-implemented method for non-linear and collaborative on-line management of a project, comprising:
accessing, via a graphical user interface, a first user account for interaction with an educational software platform that is configured to support a student account and a teacher account;
selecting an innovation project from a plurality of projects, each project of the plurality of projects being categorized by a social issue corresponding to an organizational goal; and
utilizing one or more resources built into the educational software platform to perform one or more of four phases:
(a) an understanding phase related to understanding a complexity of a problem corresponding to the social issue and how it affects people,
(b) an ideation phase related to developing ideas and potential solutions to the problem using one or more collaboration tools built into the educational software platform,
(c) a prototyping phase related to producing a prototype associated with the innovation project based on the ideas and potential solutions, and
(d) a pitch phase related to developing a presentation associated with the innovation project that highlights the prototype,
wherein performing the one or more of the four phases includes performing the phases (a), (b), and (c) in a non-linear manner that includes accessing the phases (a), (b), and (c) any particular number of times and in any particular order to enable a user of the first user account to achieve one or more learning objectives without relying on a predetermined or customized curriculum that can be accessed through the educational software platform, and
wherein the one or more resources comprise the one or more collaboration tools enabling information sharing between a plurality of student accounts and a review tool enabling two-way interaction between the teacher account and the student account.

2. The computer-implemented method of claim 1, wherein the first user account is selected from a group consisting of the student account, the teacher account, and an administrator account.

3. The computer-implemented method of claim 1, wherein the organizational goal comprises a United Nations (UN) Sustainable Development Goal (SDG) that is automatically linked to the educational software platform.

4. The computer-implemented method of claim 1, wherein the first user account is the student account, and wherein the one or more collaboration tools enables the first user account to identify one or more other student accounts without input from the teacher account.

5. The computer-implemented method of claim 1, wherein each of the four phases is accessible via the graphical user interface that simultaneously displays corresponding icons for each of the four phases.

6. The computer-implemented method of claim 1, wherein each of the four phases is systematically divided into three steps: (1) explore, (2) do, and (3) document, which can be accessed via the graphical user interface upon selection of a particular one of the four phases.

7. The computer-implemented method of claim 6, wherein each of the four phases and each of three steps associated with each phase can be accessed in any particular order to enable a non-linear innovation process.

8. The computer-implemented method of claim 1, further comprising:
accessing, via the graphical user interface, an additional software portal capable of receiving and uploading documents associated with one or more of the plurality of projects from multiple users.

9. The computer-implemented method of claim 8, further comprising:
automatically including an assigned status indicator tag associated with each project to indicate a status of the documents associated with the corresponding project.

10. The computer-implemented method of claim 9, wherein the assigned status indicator tag indicates a completed status, an approved status, or a returned status.

11. The computer-implemented method of claim 1, further comprising:
automatically storing, on a periodic basis, the plurality of projects and information generated in any of the four phases in a database coupled to the educational software platform.

12. A non-transitory computer-readable storage medium having instructions stored thereupon for non-linear and collaborative on-line management of a project, comprising:
instructions for displaying, via a graphical user interface (GUI) to a user, an account login or account creation dialog box;
instructions for receiving, from the user, user credentials that correspond to a student account or a teacher account on an educational software platform;
instructions for displaying, upon verification of the user credentials, a first plurality of icons corresponding to a plurality of projects, each project of the plurality of projects being categorized by a social issue corresponding to an organizational goal;
instructions for receiving an innovation project selection from the plurality of projects;
instructions for displaying, for a selected innovation project, a second plurality of icons corresponding to four phases:
(a) an understanding phase related to understanding a complexity of a problem corresponding to the social issue and how it affects people,
(b) an ideation phase related to developing ideas and potential solutions to the problem using one or more collaboration tools built into the educational software platform,
(c) a prototyping phase related to producing a prototype associated with the selected innovation project based on the ideas and potential solutions, and
(d) a pitch phase related to developing a presentation associated with the selected innovation project that highlights the prototype;
instructions for receiving a phase selection from the four phases; and
instructions for displaying, for a selected phase, a third plurality of icons corresponding to three steps:
(i) an exploration step configured to provide the user with information and resources related to the selected innovation project and the social issue,
(ii) an activity step configured to enable the user to perform one or more of a plurality of activities related to the selected innovation project, and
(iii) a documentation step configured to enable the user to link one or more documents to the selected innovation project,
wherein performing the one or more phases includes performing the four phases and three steps in a non-linear manner that includes accessing the four phases and three steps any particular number of times and in any particular order to enable the user to achieve one or more learning objectives without relying on a predetermined or customized curriculum that can be accessed through the educational software platform.

13. The computer-readable storage medium of claim 12, wherein the organizational goal comprises a United Nations (UN) Sustainable Development Goal (SDG) that is automatically linked to the educational software platform.

14. The computer-readable storage medium of claim 12, wherein the user is a student user, and wherein the educational software platform comprises one or more collaboration tools that enable the user to identify one or more other students without input from the teacher account.

15. A device for non-linear and collaborative on-line management of a project, comprising:
a processor and a memory including instructions stored thereupon, wherein the instructions upon execution by the processor cause the processor to:
access, via a graphical user interface, a first user account for interaction with an educational software platform that is configured to support a student account and a teacher account;
select an innovation project from a plurality of projects, each project of the plurality of projects being categorized by a social issue corresponding to an organizational goal; and
utilize one or more resources built into the educational software platform to perform one or more of four phases:
(a) an understanding phase related to understanding a complexity of a problem corresponding to the social issue and how it affects people,
(b) an ideation phase related to developing ideas and potential solutions to the problem using one or more collaboration tools built into the educational software platform,
(c) a prototyping phase related to producing a prototype associated with the innovation project based on the ideas and potential solutions, and
(d) a pitch phase related to developing a presentation associated with the innovation project that highlights the prototype,
wherein performing the one or more of the four phases includes performing the phases (a), (b), and (c) in a non-linear manner that includes accessing the phases (a), (b), and (c) any particular number of times and in any particular order to enable a user of the first user account to achieve one or more learning objectives without relying on a predetermined or customized curriculum that can be accessed through the educational software platform, and wherein the one or more resources comprise the one or more collaboration tools enabling information sharing between a plurality of student accounts and a review tool enabling two-way interaction between the teacher account and the student account.

16. The device of claim 15, wherein the organizational goal comprises a United Nations (UN) Sustainable Development Goal (SDG) that is automatically linked to the educational software platform.

17. The device of claim 15, wherein each of the four phases is systematically divided into three steps: (1) explore, (2) do, and (3) document, which can be accessed via the graphical user interface upon selection of a particular one of the four phases.

18. The device of claim 17, wherein each of the four phases and each of three steps associated with each phase can be accessed in any particular order to enable a non-linear innovation process.

19. The device of claim 15, wherein the first user account is selected from a group consisting of the student account, the teacher account, and an administrator account.

20. The device of claim 15, wherein the processor is further configured to:
display, via the graphical user interface, some or all of the plurality of projects; and
use one or more criteria to filter the displayed projects, the one or more criteria comprising the social issue, the organizational goal, a completion status or an in-progress status of any one of the four phases.

21. The device of claim 20, wherein the processor is further configured to:
configure, based on the one or more criteria, the educational software platform for access by a second user account that is different from the student account and the teacher account.
